(19) United States
(12) Patent Application Publication
(10) Pub. No.: US 2014/0129331 A1
(43) Pub. Date: May 8, 2014

(54) SYSTEM AND METHOD FOR PREDICTING MOMENTUM OF ACTIVITIES OF A TARGETED AUDIENCE FOR AUTOMATICALLY OPTIMIZING PLACEMENT OF PROMOTIONAL ITEMS OR CONTENT IN A NETWORK ENVIRONMENT

(71) Applicant: BOTTLENOSE, INC., Sherman Oaks, CA (US)

(72) Inventors: Nova T. Spivack, Sherman Oaks, CA (US); Dominiek ter Heide, Amsterdam (NL)

(73) Assignee: BOTTLENOSE, INC., Sherman Oaks, CA (US)

(21) Appl. No.: 14/073,693

(22) Filed: Nov. 6, 2013

Related U.S. Application Data
(63) Continuation of application No. 14/073,275, filed on Nov. 6, 2013.
(60) Provisional application No. 61/723,280, filed on Nov. 6, 2012.

(51) Int. Cl. G06Q 30/02

(52) U.S. Cl. CPC G06Q 30/0255
USPC 705/14.53

(57) ABSTRACT

Techniques are disclosed for predicting momentum of topic in the future in automatically optimizing placement of promotional items or content (e.g., advertisements) in a network. An example method comprises selecting a group of users from a user population in a network based on, for example, a degree of association between (i) multiple key words and (ii) profile data or past activities from the user population. The method further comprises monitoring activities performed in the network by the group of users. The method further comprises identifying a topic from the activities, and determining momentum for the topic. The method further comprises predicting a future momentum for the identified topic based on observing additional topics which are related to the identified topic and have momentums with a rate of growth that exceeds a positive or negative threshold.

### CROSS-REFERENCE TO RELATED APPLICATIONS AND EFFECTIVE FILING DATE ENTITLEMENT

This application is a continuation application of U.S. patent application Ser. No. 14/073,275, entitled “SYSTEM AND METHOD FOR DYNAMICALLY PLACING AND SCHEDULING OF PROMOTIONAL ITEMS OR CONTENT BASED ON MOMENTUM OF ACTIVITIES OF A TARGETED AUDIENCE IN A NETWORK ENVIRONMENT” (Attorney Docket No. 76584-8008.US01), filed Nov. 6, 2013, which claims the benefit of and the right of priority to U.S. Provisional Patent Application No. 61/723,280, entitled “SYSTEMS AND METHOD FOR CONTINUOUS AND REAL-TIME OR NEAR REAL-TIME TARGETING OF SOCIAL NETWORK ADVERTISEMENTS AND OTHER PROMOTIONAL CONTENT” (Attorney Docket No. 76584-8008.US00), filed Nov. 6, 2012; all of which are hereby incorporated by reference in their entireties. This application is therefore entitled to an effective filing date of Nov. 6, 2012.

This application is related to U.S. patent application Ser. No. 13/403,962, entitled “SYSTEMS AND METHODS FOR RECOMMENDING ADVERTISEMENT PLACEMENT BASED ON IN NETWORK AND CROSS NETWORK ONLINE ACTIVITY ANALYSIS” (Attorney Docket No. 76584-8006.US01), filed Feb. 23, 2012, which claims the benefit of U.S. Provisional Application No. 61/446,001, filed Feb. 23, 2011, entitled “INFORMATION STREAM PERSONALIZATION AND FILTERING” (Attorney Docket No. 76584-8001.US00); U.S. Provisional Application No. 61/449,033, filed Mar. 3, 2011, entitled “INFORMATION STREAM PERSONALIZATION AND FILTERING” (Attorney Docket No. 76584-8001.US01); U.S. Provisional Application No. 61/591,696, filed Jan. 27, 2012, entitled “TRENDING OF PERSONALIZED INFORMATION STREAMS AND MULTI-DIMENSIONAL GRAPHICAL DEPICTION THEREOF” (Attorney Docket No. 76584-8002.US00); U.S. Provisional Application No. 61/599,355, filed Feb. 15, 2012, entitled “INTELLIGENT SOCIAL MEDIA STREAM FILTERING FOR BUSINESS PROCESS ENHANCEMENT” (Attorney Docket No. 76584-8004.US00); and U.S. Provisional Application No. 61/600,553, filed Feb. 17, 2012, entitled “NATURAL LANGUAGE PROCESSING OPTIMIZED FOR MICRO CONTENT” (Attorney Docket No. 76584-8005.US00); the content of which are incorporated by reference in their entireties.

This application is also related to Patent Cooperation Treaty (PCT) application Ser. No. ______, entitled “SYSTEM AND METHOD FOR DYNAMICALLY PLACING AND SCHEDULING OF PROMOTIONAL ITEMS OR CONTENT BASED ON MOMENTUM OF ACTIVITIES OF A TARGETED AUDIENCE IN A NETWORK ENVIRONMENT” (Attorney Docket No. 76584-8008.WO00), filed Nov. 6, 2013; Great Britain Patent Application No. 1319593.8, entitled “SYSTEM AND METHOD FOR DYNAMICALLY PLACING AND SCHEDULING OF PROMOTIONAL ITEMS OR CONTENT BASED ON MOMENTUM OF ACTIVITIES OF A TARGETED AUDIENCE IN A NETWORK ENVIRONMENT” (Attorney Docket No. 76584-8008.GB00), filed Nov. 6, 2013; all of which are hereby incorporated by reference in their entireties.

### BACKGROUND

Through web-based media services like Twitter and Facebook, a user of a network (e.g., in a social network) is exposed to a vast amount of information from hundreds if not thousands of messages or other activities from different online sources including friends and merchants, culminating in a massive information overload. Traditional ways and strategies of populating advertisement may become less relevant, thereby rendered ineffective to attract audiences that are already overloaded with information.

Many online service provider tries to improve this problem by key word advertising, where the advertisements are linked to specific words or phrases. For example, whenever the user's profile or postings may have those key words bought by merchant clients for their advertisements, the advertisements can show up or populated to the user audience. However, this approach is typically static and lacks responsiveness to the volatile nature of ever-changing topics and trends happening in the network.

### BRIEF DESCRIPTION OF THE DRAWINGS

FIG. 1 illustrates an example block diagram of a host server of able to dynamically place, schedule, and adjust promotional items based on momentum of activities of a targeted audience in a network.

FIG. 2A depicts an example block diagram showing the various origins and destinations of messages which can be analyzed by the host server.

FIG. 2B depicts a diagram showing examples of media services whose messages can be analyzed for various applications.

FIG. 3A depicts an example block diagram of a host server able to analyze messages in or across networks for various applications.

FIG. 3B depicts an example block diagram of the user assistance engine in the host server able to perform various customized actions on messages including to personalize and/or filter messages for users.

FIG. 3C depicts an example block diagram of the content targeting engine of the host server able to recommend ad or placement of other promotional content based on trends identified from the analysis of activities occurring in or across networks.

FIG. 3D depicts another example block diagram of the content targeting engine of FIG. 3C with additional or alternative details which can enable the content targeting engine to dynamically place, schedule, and adjust promotional items based on momentum of activities of a targeted audience in a network.

FIG. 3E depicts an example block diagram of the trend detection and prediction engine of FIG. 3C which can predict momentum of topics in automatically optimizing placement of promotional items in a network.

FIG. 4A illustrates an example entry in a user analytics repository.

FIG. 4B illustrates an example entry in a message analytics repository.

FIG. 4C illustrates a table showing various configuration settings in a semantic rules set.

FIG. 5 illustrates an example architecture of a system which analyzes messages in a network or across networks to/from various online media sites and/or users.

FIG. 6 illustrates another example architecture of a system which analyzes messages in a network or across networks to/from various online media sites and/or users.

FIG. 7 depicts a flow chart illustrating an example process for aggregating an online identity of a user from activities at social media sites.

FIG. 8 depicts an example flow chart illustrating an example process for targeting content placement using online identifies aggregated a user's online activities.

FIG. 9 depict example flow charts illustrating example processes for targeting content placement based on real time online activities of the user and enriching a third party user profile.

FIG. 10 depicts a flow chart illustrating an example process for recommending promotional item placement for an advertiser based on trends identified from activities occurring in or across networks.

FIG. 11 depicts a flow chart illustrating an example process for dynamically placing, scheduling, and adjusting promotional items based on momentum of activities of a targeted audience in a network.

FIG. 12 depicts a flow chart illustrating an example process for predicting momentum of topic in the future in automatically optimizing placement of promotional items in a network.

FIG. 13 depicts an example interface which the host server can automatically generate in suggesting trend, momentum, key words and possible grouping thereof, to an administrator.

FIG. 14 shows a diagrammatic representation of a machine in the example form of a computer system within which a set of instructions, for causing the machine to perform any one or more of the methodologies discussed herein, may be executed.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems and methods for continuous and real-time or near real-time targeting of social network promotional item or content (e.g., an advertisement). The disclosed techniques are able to continuously update and optimize the targeting of an advertisement, or advertisement campaign (e.g., a series of advertisements over a period of time), or other promotional content in a social network, based on real-time measurement of trends (e.g., momentum of topics) in a social network.

More specifically, techniques are disclosed for dynamically placing, scheduling, and adjusting promotional items based on momentum of activities of a targeted audience in a network. An example method comprises selecting a group of users from a user population in a network. The selection can be based on a degree of association between (i) multiple key words and (ii) profile data or past activities from the user population. The method further comprises monitoring activities performed in the network by the group of users. The method further comprises identifying a topic from the activities. The method further comprises determining momentum for the topic. The momentum can be proportional to (i) a number of how many users whose activities mention the topic and (ii) a frequency of how often the topic is mentioned. The method further comprises selectively delivering promotional item or content to the group of users based on the momentum for the identified topic.

In addition, techniques are disclosed for predicting momentum of topic in the future in automatically optimizing placement of promotional items or content (e.g., advertisements) in a network. An example method comprises selecting a group of users from a user population in a network based on, for example, a degree of association between (i) multiple key words and (ii) profile data or past activities from the user population. The method further comprises monitoring activities performed in the network by the group of users. The method further comprises identifying a topic from the activities; determining momentum for the topic. The momentum is proportional to and computed from, for example, (i) a number of how many users whose activities mention the topic and (ii) a frequency of how often the topic is mentioned. The method further comprises predicting a future momentum for the identified topic based on observing additional topics which are related to the identified topic and have momentums with a rate of growth that exceeds a positive or negative threshold. The method further comprises selectively delivering promotional content to the group of users based on the future momentum for the identified topic.

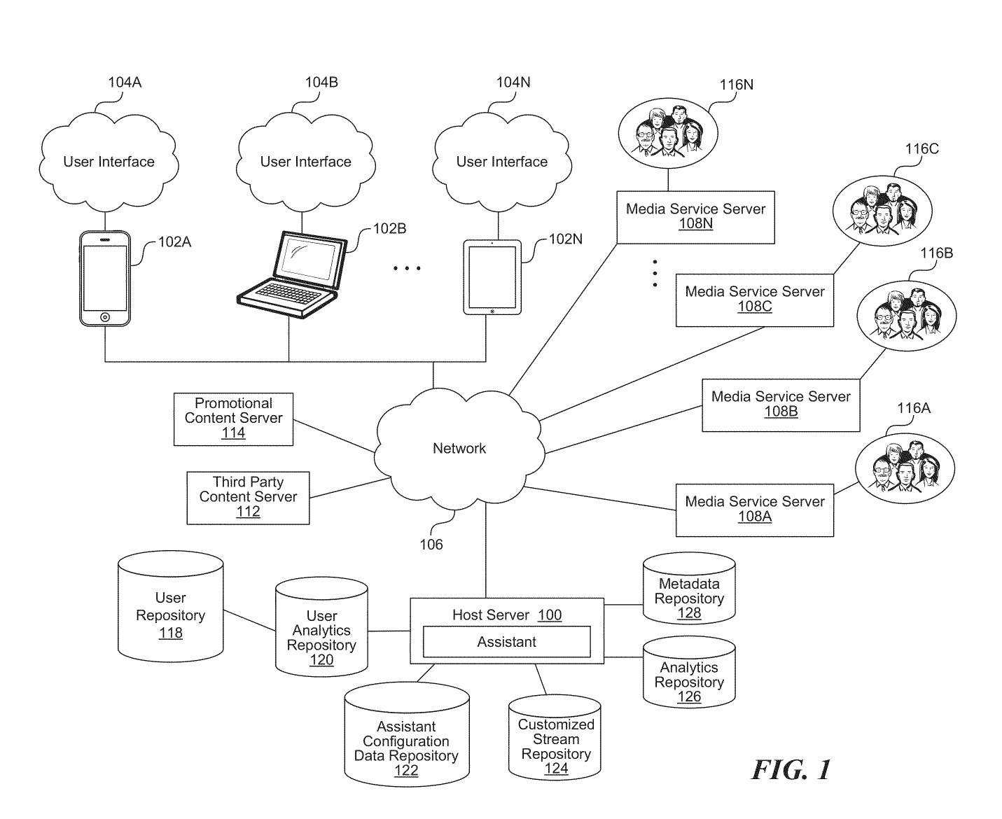

FIG. 1 illustrates an example block diagram of a host server 100 of able to analyze messages in a network 106 or across networks including messages to or from various online media services (hosted by media service servers 108A-N), third party content servers 112, and/or promotional content server 114.

The client devices 102A-N can be any system and/or device, and/or any combination of devices/systems that is able to establish a connection with another device, a server and/or other systems. Client devices 102A-N each typically include a display and/or other output functionalities to present information and data exchanged between among the devices 102A-N and the host server 100.

For example, the client devices 102 can include mobile, hand held or portable devices or non-portable devices and can be any of, but not limited to, a server desktop, a desktop computer, a computer cluster, or portable devices including, a notebook, a laptop computer, a handheld computer, a palmtop computer, a mobile phone, a cell phone, a smart phone, a PDA, a Blackberry device, a Treo, a handheld tablet (e.g. an iPad, a Galaxy, Xoom Tablet, etc.), a tablet PC, a thin-client, a hand held console, a hand held gaming device or console, an iPhone, and/or any other portable, mobile, hand held devices, etc. The input mechanism on client devices 102 can include touch screen keypad (including single touch, multi-touch, gesture sensing in 2D or 3D, etc.), a physical keypad, a mouse, a pointer, a track pad, motion detector (e.g., including 1-axis, 2-axis, 3-axis accelerometer, etc.), a light sensor, capacitance sensor, resistance sensor, temperature sensor, proximity sensor, a piezoelectric device, device orientation detector (e.g., electronic compass, tilt sensor, rotation sensor, gyroscope, accelerometer), or a combination of the above.

The client devices 102A-N, media service servers 108A-N, the respective networks of users 116A-N, a content server 112, and/or promotional content server 114, can be coupled to the network 106 and/or multiple networks. In some embodiments, the devices 102A-N and host server 100 may be directly connected to one another. The media services hosted by the media service servers 108A-N can include any online or web-based media services or networking services whereby a crowd or network of users contribute to the distribution of original or reposted content. These media services include, for example, Twitter, Facebook, Google+, Linkedin, and any other sites, services, or platforms where users can share information and networks with other users.

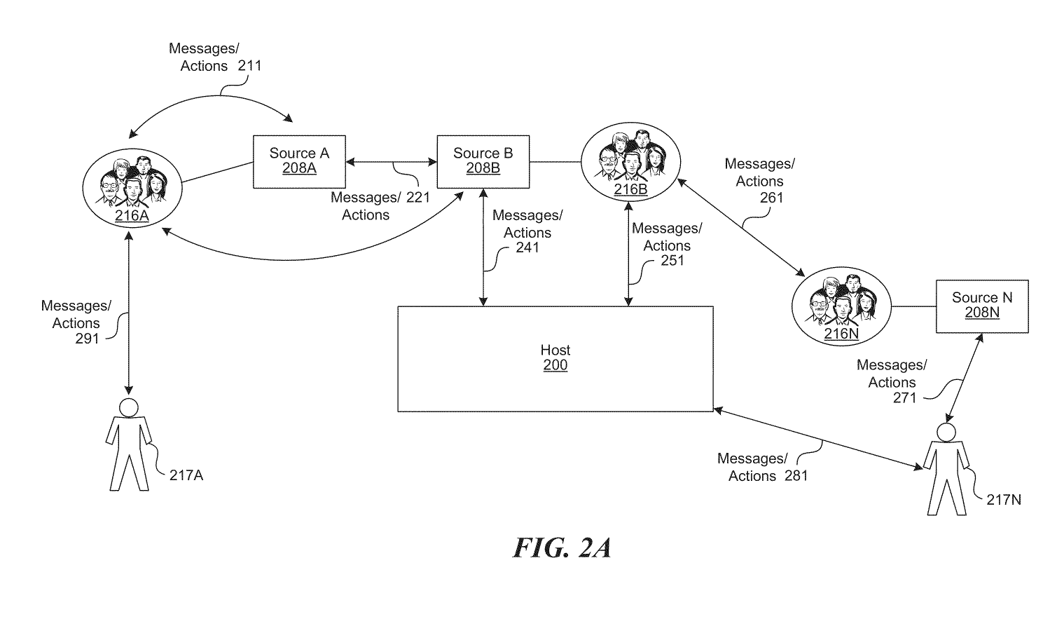

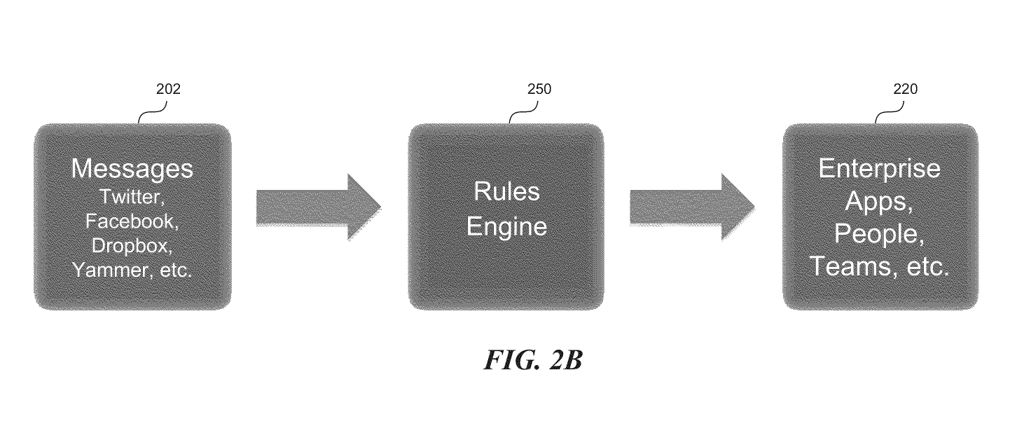

In one embodiment, the host server 100 is operable to analyze streams or sets of messages in a network or across networks to extract statistics to determine useful data such as trends, topics, behaviors, etc. The streams or sets of messages/content can be the target of any online or network-based activity, some of which are illustrated in the example of FIG. 2A. For example, any message or content resulting from or as the basis of activities between users and a network resource (e.g., content provider, networking site, media service provider, online promoter, etc.) can be analyzed for which analytics can be used for various applications including, content/message personalization/customization and filtering, trend/popularity detection (on certain sites (e.g., what's popular on Twitter in the last 2 hours), across all sites or select sets of sites, over a certain time period, in a certain geographical locale (e.g., in the United State), as relating to a certain topic (e.g., what's trending in sports right now), etc.) or a combination of the above. Additional applications include targeted advertising from a user-driven facet, platform-driven facet, timing-facet, delivery-style/presentation-style-facet, advertiser-facet, or any combination of the above.

In general, the host server 100 operates in real-time or near real-time and is able to generate useful analytics/statistics regarding network or online activity to detect current trends or predict upcoming trends for various applications. Delay time analytics and statistics can also be extracted in any specified timing window. In one embodiment, message/content analytics can also be used in generating unique user interfaces and UI features useful for displaying trends or popular topics/types/people/content in an intuitive manner for navigation.

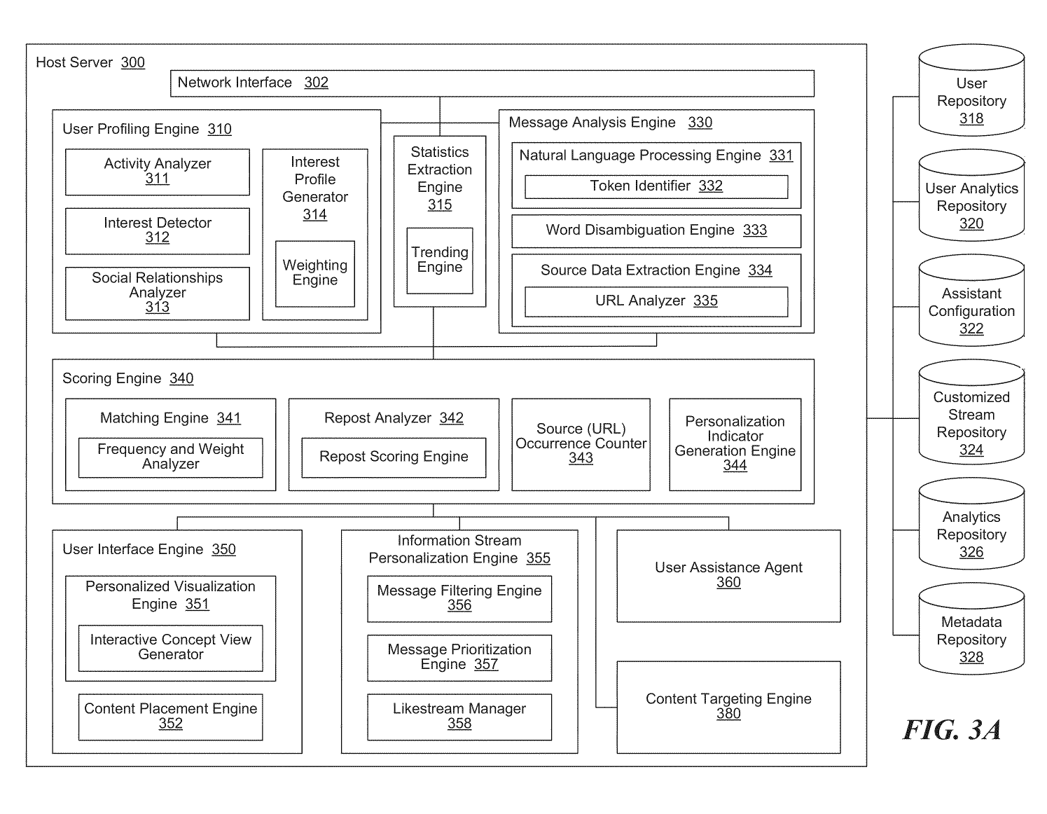

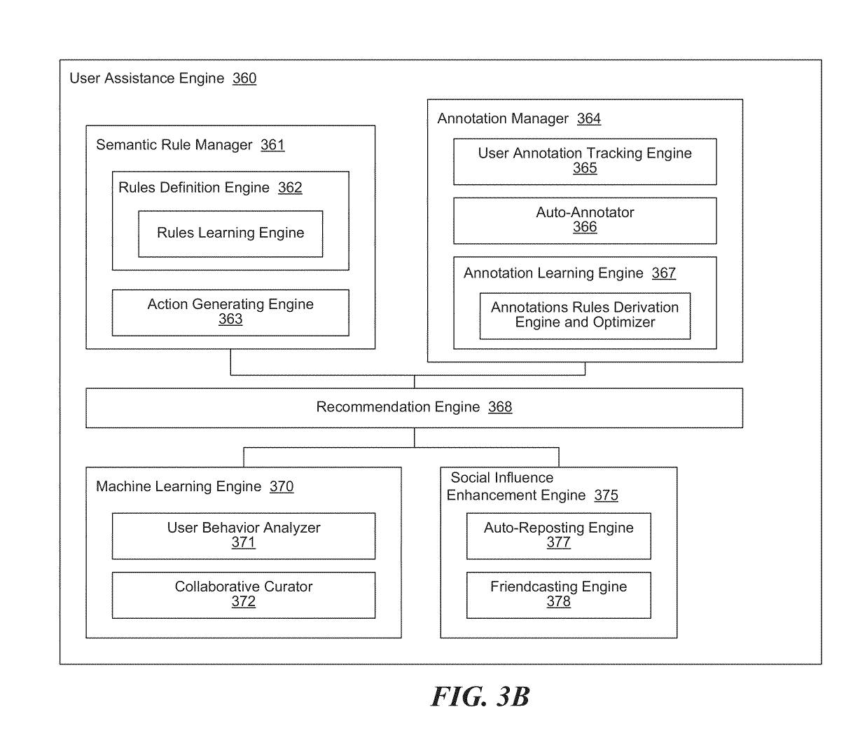

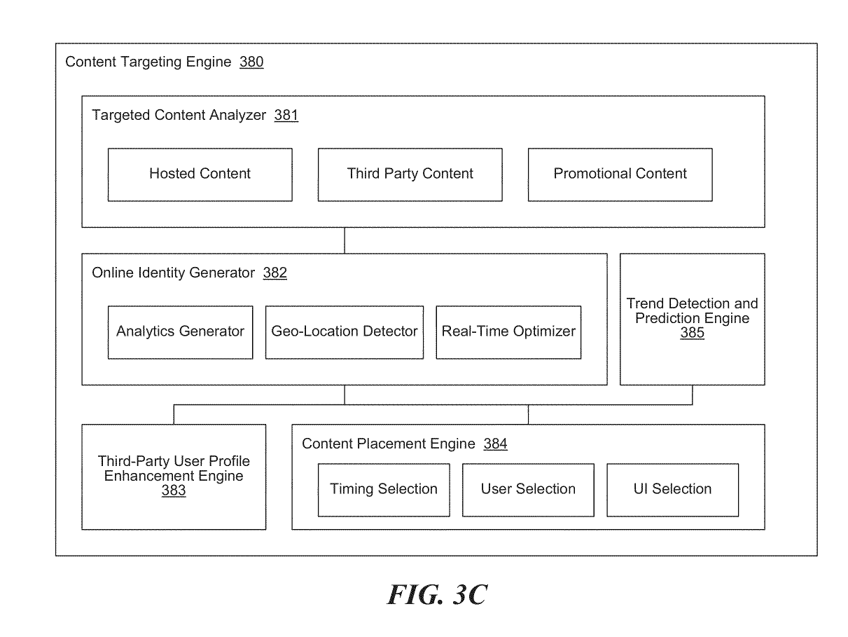

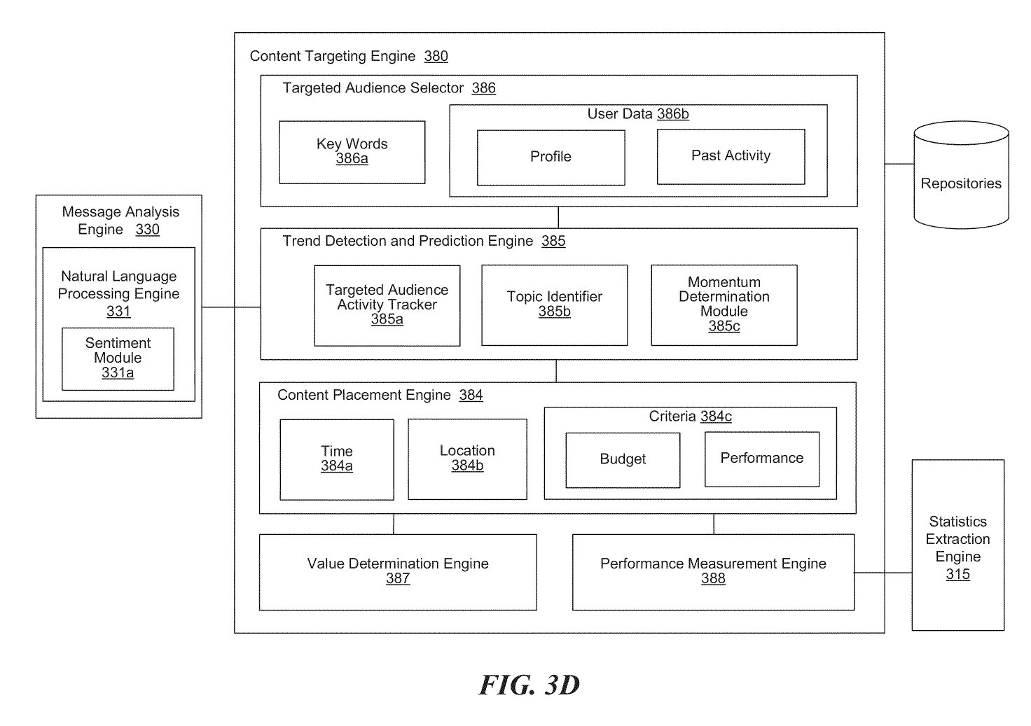

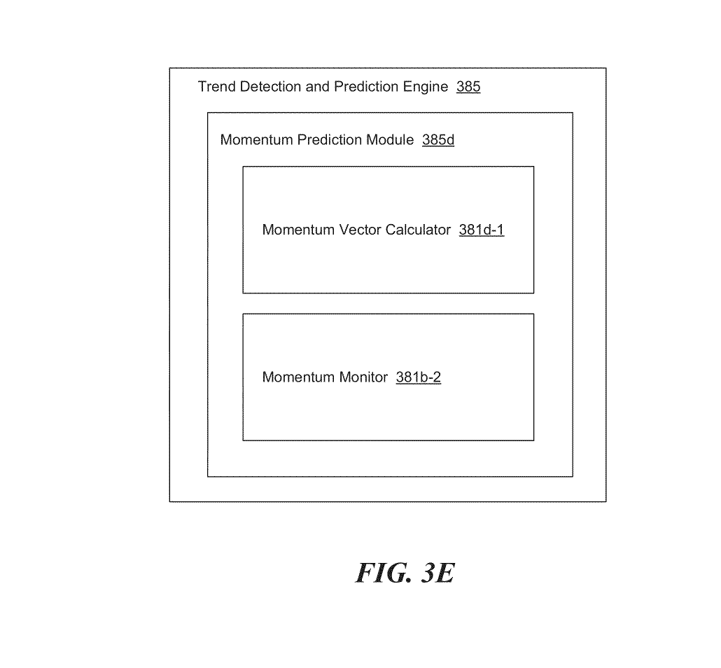

Functions and techniques performed by the host server 100 and the components therein are described in detail with further references to the examples of FIGS. 3A-B.

In general, network 106, over which the client devices 102A-N, the host server 100, and/or various media service servers 108A-N, content server 112, and/or promotional content server 114 communicate, may be a cellular network, a telephonic network, an open network, such as the Internet, or a private network, such as an intranet and/or the extranet, or any combination thereof. For example, the Internet can provide file transfer, remote log in, email, news, RSS, cloud-based services, instant messaging, visual voicemail, push mail, VoIP, and other services through any known or convenient protocol, such as, but is not limited to the TCP/IP protocol, Open System Interconnection (OSI) protocols, FTP, UPnP, iSCSI, NSF, ISDN, PDH, RS-232, SDH, SONET, etc.

The network 106 can be any collection of distinct networks operating wholly or partially in conjunction to provide connectivity to the client devices 102 and the host server 100 and may appear as one or more networks to the serviced systems and devices. In one embodiment, communications to and from the client devices 102 can be achieved by an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more networks, such as, but are not limited to, one or more of WiMax, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), enabled with technologies such as, by way of example, Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G, IMT-Advanced, pre-4G, 3G LTE, 3GPP LTE, LTE Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, UMTS-TDD, 1xRTT, EV-DO, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The host server 100 may include internally or be externally coupled to a user repository 118, a user analytics repository 120, a configuration data repository 122, a customized stream repository 124, an analytics repository 126 and/or a metadata repository 128. The repositories can store software, descriptive data, images, system information, drivers, and/or any other data item utilized by other components of the host server 100 and/or any other servers for operation. The repositories may be managed by a database management system (DBMS), for example but not limited to, Oracle, DB2, Microsoft Access, Microsoft SQL Server, PostgreSQL, MySQL, FileMaker, etc.

The repositories can be implemented via object-oriented technology and/or via text files, and can be managed by a distributed database management system, an object-oriented database management system (OODBMS) (e.g., ConceptBase, FastDB Main Memory Database Management System, JDOlnstruments, ObjectDB, etc.), an object-relational database management system (ORDBMS) (e.g., Informix, OpenLink Virtuoso, VMDS, etc.), a file system, and/or any other convenient or known database management package.

In some embodiments, the host server 100 is able to provide data to be stored in the user repository 118, the user analytics repository 120, the configuration data repository 122, the customized stream repository 124, the analytics repository 126 and/or the metadata repository 128. The user repository 128 and/or user analytics repository 120 can store user information, user profile information, demographics information, analytics, statistics regarding consumed content and posted content, user influence, usage trends, trending topics, search terms, search trends, user response rates, topics of interest, online activity profile, topics of expertise, social relationships, friends on various networks or online media sites, social statistics (growth in friends, change in influence, level of sentiment or trust about them from others, where they fit in the social graph, who they are related to, who they are similar to), etc.

One embodiment further includes the assistant configuration data repository 122 which can store rule sets which specify actions to be performed on a message based on a detected condition or sets of conditions, for a given user or users meeting certain criteria, etc. The rule sets can be user defined or machine created (e.g., from machine learning user behavior or aggregate user behavior) to customize the way messages and content from various sources are organized and presented to a user or groups of users. The customized stream repository 124 can store streams of messages or content that is personalized or customized to individual users including streams with liked content, filtered content, categorized based on topic, type, content, associated users, people, related sites or sources, and/or prioritized content based on relevance or importance.

One embodiment further includes the analytics repository 126 which can store analytics or statistical data regarding messages, content, websites, searches, media network activity, or any online or network activity surrounding messages, content, people, events, online media sites, social media sites, content providers, any other third party services or online services, etc. The metadata repository 128 stores metadata for online content and messages. The metadata can be machine annotated or user annotated and can include both static and/or dynamic metadata which specifies semantic type or attributes of messages or other content.

Specifically, the metadata can be extracted or attached to messages/content in or across networks 106 by the host server 100. Metatdata can also include formatting and display information such as a custom avatar image, background, layout, font choice, stylesheet or CSS attributes. Message metadata can be extended by plug-ins as well, enabling additional layers of metadata and functionality to be added to messages via the host server 100.

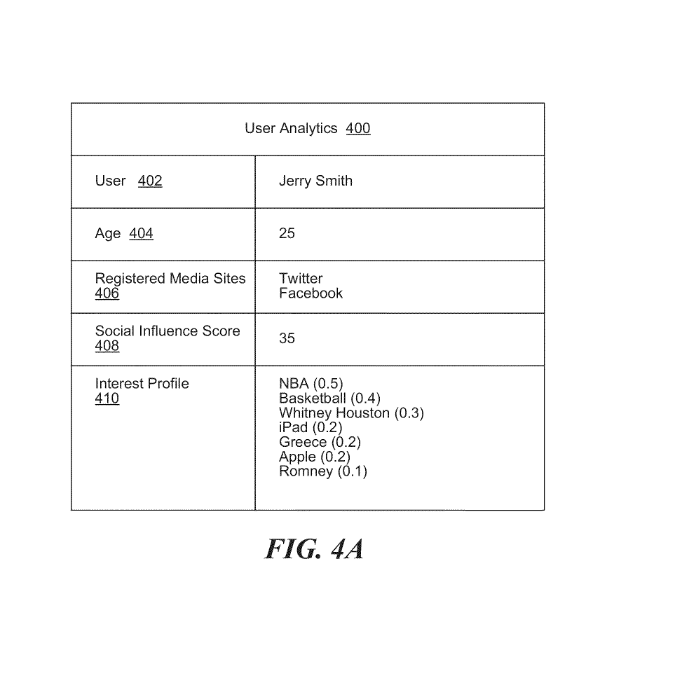

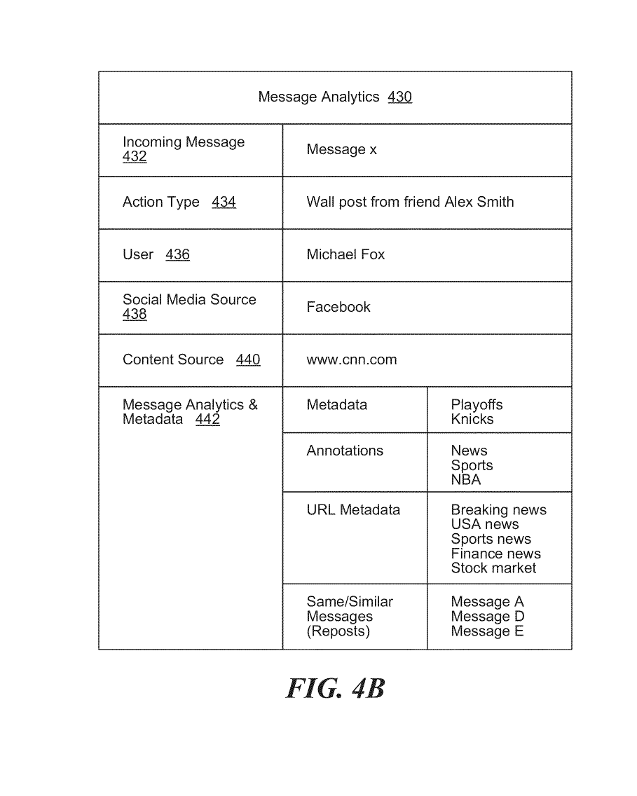

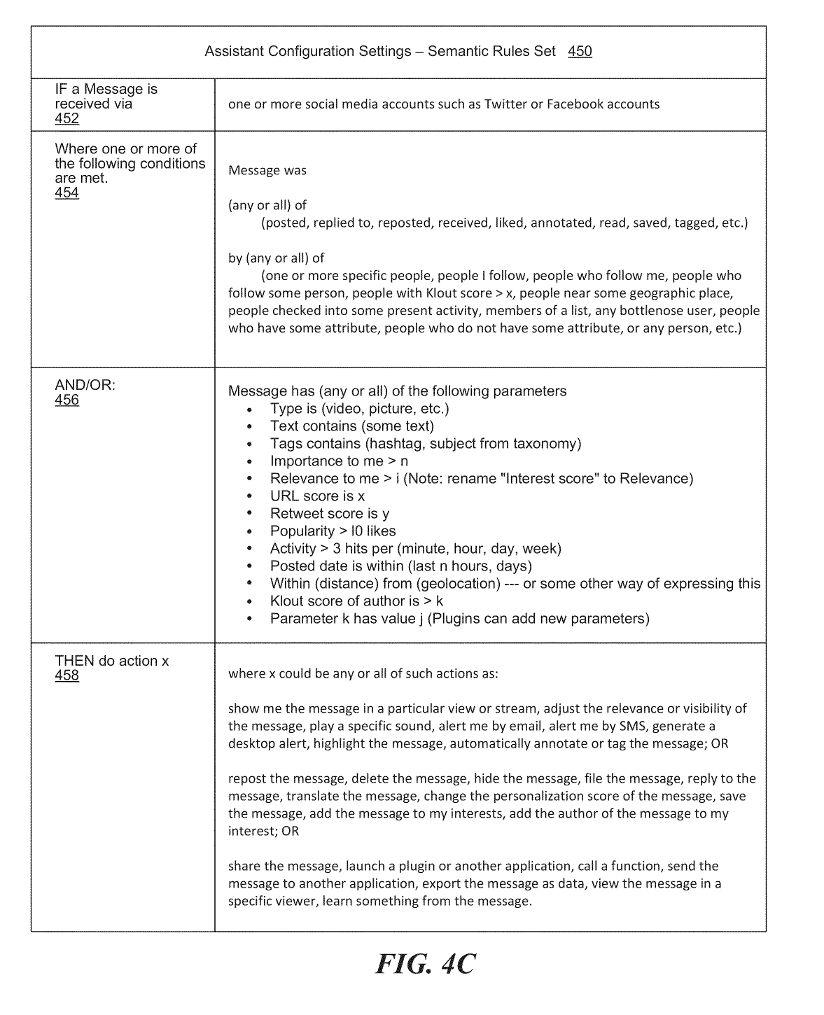

Additional details of examples of types of data stored in repositories are illustrated with further reference to database entries shown in examples of FIG. 4A-FIG. 4C. More implementation details on the promotional item/content (e.g., advertisement) placing, and adjusting techniques which can be implemented on the host server 100 to render promotional item/content (e.g., advertisement) on user devices 102A-N (e.g., via user interfaces 104A-N) are discussed in fuller detail below, and particularly with regard to FIG. 3A-FIG. 3E.

FIG. 2A depicts an example block diagram showing the various origins and destinations of messages/actions and/or content that are the subject of online or network activity. Any message/action/content that is the subject of online or network activity which is user-driven or machine-driven can be detected and analyzed by the host server 200 to extract useful information for trending, personalization, customizing, or filtering purposes. The content sources 208A-N and users 216A-N and 217 can be destinations/origins of any message/content or be the originator/recipient on an action performed on a message/content.

Actions can include, by way of example but not limitation, posted, replied to, reposted, received, liked, annotated, read, saved, favorited, bookmarked, viewed, deleted, tagged, commented, tweeted, linked, searched for, etc. Messages and/or content can generally include, messages associated with video content, messages associated audio content, and messages associated photos, any message interacted with by humans or machines, user profiles, user events, user likes or dislikes, status updates, mentions, news, news feeds, current events, breaking news, tweets, messages associated links, notes, web pages, documents, email messages, comments, chat messages/logs, SMS messages, etc.

Messages or content 211 can be sent between a network of users 216A of a content source A 208A (e.g., an online networking site or other content sharing/networking sites) or be the subject of online activity by users 216A of the online site of content source A 208A. The messages and/or content 221 analyzed can also be transmitted between sites (e.g., source A 208A and source B 208B).

The messages and/or content can include messages 291 acted upon between a user 217A and a social network of user 216A, messages 231 between a social network of users 216A and a different online network site (e.g., content source 208A), messages 241 acted upon between the host 200 and a content source (e.g., content source B 208B), messages/content 251 between a network of users 216B (e.g., users of Facebook or Twitter) and host server 200, messages/content 261 acted upon between users of different online networks (e.g., 216B and 216N), or messages/content 271 between any user 217N (e.g., a user who is not necessarily part of a given social network or any social network) and a source N 208N, or content/messages 281 between any user 217N directly to the host 200.

FIG. 2B depicts a diagram showing examples of media services whose messages can be analyzed for various applications. The set of messages/content in question can be analyzed in accordance to set of rules applied by the rules engine. The results of the analysis and statistics can be used in various applications including individual users, for enterprises/companies or organizations, for teams of people or for specific applications, for detecting, identifying trends, filtering/prioritizing according to topics/trends/what's popular, and for generating interactive user interfaces which depict trends or popular topics/ideas/concepts updatable in real time or near real time. The interactive UI may also be actionable to navigate to or through related topics, tags, ideas, people, users, or content.

FIG. 3A depicts an example block diagram of a host server 200 able to analyze messages in or across networks for various applications.

The host server 300 can include, for example, a network interface 302, a user profiling engine 310, a message analysis engine 330, a scoring engine 340, a user interface engine 350, an information stream personalization engine 355, a user assistance agent 360, and/or a content targeting engine 380. Additional or less components/modules/engines can be included in the host server 300 and each illustrated component.

The network interface 302 can be a networking module that enables the host server 300 to mediate data in a network with an entity that is external to the host server 300, through any known and/or convenient communications protocol supported by the host and the external entity. The network interface 302 can include one or more of a network adaptor card, a wireless network interface card (e.g., SMS interface, WiFi interface, interfaces for various generations of mobile communication standards including but not limited to 1G, 2G, 3G, 3.5G, 4G, LTE, etc.,), Bluetooth, a router, an access point, a wireless router, a switch, a multilayer switch, a protocol converter, a gateway, a bridge, bridge router, a hub, a digital media receiver, and/or a repeater.

As used herein, a “module,” a “manager,” an “agent,” a “tracker,” a “handler,” a “detector,” an “interface,” or an “engine” includes a general purpose, dedicated or shared processor and, typically, firmware or software modules that are executed by the processor. Depending upon implementation-specific or other considerations, the module, manager, tracker, agent, handler, or engine can be centralized or its functionality distributed. The module, manager, tracker, agent, handler, or engine can include general or special purpose hardware, firmware, or software embodied in a computer-readable (storage) medium for execution by the processor.

As used herein, a computer-readable medium or computer-readable storage medium is intended to include all mediums that are statutory (e.g., in the United States, under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, to name a few), but may or may not be limited to hardware.

One embodiment of the host server 300 includes the user profiling engine 310. The user profiling engine 310 can be any combination of software agents and/or hardware modules (e.g., including processors and/or memory units) able to detect, aggregate, generate, create, predict, retrieve, determine, identity user interests and creating a profile from the user's interests, based from a user's online or network-based activities.

The user profiling engine 310 can, for example, determine the interests of a user without requiring any interaction other than to provide an online identity (e.g. Twitter or Facebook username or other online sites). The user profiling engine 310 can generate an interest profile (e.g., via the interest profile generator 314) with a list of concepts/topics that are of interest to a user. The concepts that are listed may be weighted (e.g., by the weighting engine) in accordance with level of relevance or level of interest to the user. For example, if a user is interested in the company “Microsoft” as detected from his/her feeds, status updates, messages, emails, etc. this word can appear in that profile, and it can be further weighted based on a level of interest as compared to other concepts/topics in the user's interest profile.

The user profile further includes an activity analyzer 311 which detects various user activities online for use in analyzing user behavior to detect/identify user interests in generating the interest profile. The activities that can be detected and analyzed include, by way of example, posted a message, shared a message, liked a message, favorited a message, tagged a message, annotated a message, rated a message, and commented on the message, replied to the message, viewed the message, saved or bookmarked the message.

The activities can also include activities/social relationships relating to other users as detected or analyzed by a social relationships analyzer 313 of the user profiling engine 310. For example, people parameters of people who interacted with a message, people who a user is friends with or connected to, followed people, following people, people who follow specified other people, people with a certain social influence level, geographical parameters of the people, membership or group affiliation, degrees of separation, screen name of an author, author follower count, author following count, author average messages per day.

User interests can be detected by the interest detector 312 by analyzing user content provided in the online activity at or via the online media services, the user content including user-submitted content or user-generated content. The interests of the user can also be determined from other users with whom the user is connected or is friends in the online media services.

The statistics extraction engine 315 reviews the results of the analysis and extracts quantitative information about the user and the associated interests. In one embodiment, the interests of the user are represented by concepts weighted according to analysis of user content which is subject of the online activities at the online media services, an example of which is illustrated in a data entry for user analytics shown in FIG. 4A. Weights can be assigned by the weighting engine based on results of activity and message analysis.

The statistics or any qualitative data computed as a function of time in a given time period or in real time can be used to detect trends (e.g., via the trending engine), potential trends or upcoming trends from any set of messages or online activity. For example, sets of messages relating to a given user can be analyzed to identify trends in the user's interest. Messages/content relating to a given platform can be analyzed to detect what is popular on that site right now. Messages/content relating to a specific topic (e.g., sports) can be analyzed to identify what's currently popular or trending in sports news.

Concepts or topics can be identified from messages by the message analysis engine 230 through natural language processing (e.g., by the natural language processing engine 231). The identified concepts or topics can be used to build a user's interest profile or to determine the related concepts/ideas of a given message, or piece of content to further determine appropriate action. When using message analysis to build an interest profile for a given user, the following steps can be performed:

1) Retrieve messages acted on (e.g., written, liked, commented, etc.) by user X. 2) For each message, detect language tokens (e.g. semi-colons, comma's, whitespaces, others, etc.) and identify social network tokens (e.g., hash tags, @ tags, + tags, or other tags, URLs/URIs, usernames, emoticons, micro-syntax, etc.). 3) For each message, assign part-of-speech tags to words using, for example, a dictionary (e.g. noun, adjective, verb, pronoun, unknown). 4) Collect nouns, pronouns and/or unknown words from all messages and take the most frequently occurring N words. 5) Refine/optimize this list of words by omitting common words and written expressions using dictionaries. The resulting interest profile will have a list of words. Each word can be assigned a weighting which is based on how often that word occurred in user X's online activity.

In general, the above analysis process can be applied to any set of messages to retrieve a list of words which can represent the common or frequently occurring topics, themes, concepts, places, people, or things, etc. Such detection can be used to detect, identify, predict, determine trends, upcoming trends, and/or popular topics/themes/concepts from any set of messages. The set of messages can be relating those across multiple platforms/services (e.g., all messages/content/activity on Twitter, Facebook and Linkedin in the last 10 hours), across a given platform/service (e.g., all activity on Twitter in the last 2 hours), across one or more platforms/services in a given geographical local (e.g., all activity on Twitter, Facebook in San Francisco), across one or more platforms/services for a given user, or a specific group of users, across one or more platform/services as pertaining to a specific topic (e.g., US Open, NBA, etc.), or any combination of the above parameters.

For example, a user can choose to detect trends in activities for people or a group of users that he follows on Twitter, or to access trends from last week. Changes in trends can also be determined, the strength of a given trend (e.g., how rapidly some topic/concept is becoming popular) can also be computed by performing quantitative analysis on messages/content and other activities occurring across a single network or multiple networks and any number of social media platforms.

In one embodiment, the concepts that are detected can be filtered/optimized from messages/content through disambiguation of a given keyword having multiple meanings (e.g. via the word disambiguation engine 333). For example, the word “Java” has multiple meanings/contexts including, for example, Java, the island in Indonesia, is it Java, the programming language. In this instance, disambiguation processes can be performed to determine which meaning of the word is applicable.

In some instances, disambiguation can be performed by analyzing the surrounding words in the sentence that the word occurred in. In this example, the surrounding sentence could be “I′m traveling to Java next week.” VS “I was programming Java all day,” which allows a system to decide the correct definition of the word.

In one embodiment, when the user profiling engine 310 builds an interest profile for the user, all words that are found are generally of interest to a user. So for this collection of words, the word disambiguation engine 333 can use the user, or the rest of the messages, as a context to disambiguate the meaning of the words. For example, in one embodiment, a large dictionary of known words and related categories can be locally stored, externally accessed/queried. For example, the dictionary can be synthesized by combining an encyclopedia's (e.g., Wikipedia or other databases) list of topics with the categories those topics belong to.

For messages/content pertaining to a user X, or for any given set of messages, there are a list of words P that need to be disambiguated. For each word in this list, all possible meanings can be retrieved. In this example, this would be “Java (programming language)”, “Java” (the island). In one embodiment, for each meaning of each word, a list of all related categories can be determined and stored. In our example this would be “Programming, Computing, Programming Languages, etc.” and “Indonesia, Asia, Country, Geography”.

For the words in P, it can then be determined those categories that are most frequently occurring. This can be performed by counting and tracking the occurrences of each category across the words in list P. In one emobdiment, the amount of category occurrences can then be used to assign a score to each meaning of each word. In this example, if “Programming” occurred multiple times, the meaning “Java (programming language)” will get a higher score. Therefore making this the most correct meaning of the word Java in a set of messages pertaining to user X, or any given set of messages.

In addition, in one embodiment, message analysis includes using information about the message source to detect and retrieve relevant information. For example, additional information about messages can be determined by retrieving and analyzing data for relevant URLs which host the message or content. In one embodiment, each URL or other types of content sources for a set of messages can be analyzed to retrieve and store the information. In addition, browser extension (e.g., bookmarklets) can be used to facilitate this.

For example, browser extensions can be provided to the users to share pages that they like when browsing the internet. In the background however, (without bothering the user), this extension can analyze the page, extract relevant meta-data (e.g. title, description, author, popularity, type, fields, media, etc.). The extracted information about the content source (e.g., URI or URL) can be sent to the host 300 and stored in a repository (e.g., the metadata repository 328).

The scoring engine 340 can determine the relevance of any message/piece of content to a given concept/theme/trend/topic/person/place, etc. The computed relevance of content/message to a concept can be used for various applications including, placement of the content/message (site, person, timing, etc.), retrieval of the content/message when relevant (e.g., when a search is conducted for the topic or a related topic, when a related topic is queried or selected, when the topic itself if queried or selected), placement of promotional content, relevance to a group of users, personalization of message streams for users through filtering and prioritization, etc.

In one embodiment, the scoring engine 340 can generate a score by matching message content against an interest profile or one or more concepts/topics/themes. The interest profile may be for a specific user or for a specific group of users, or just for any given context. The matching can be performed by the matching engine 341 by performing natural language processing to extract relevant concepts from the message or other content. These relevant concepts are then assigned a score by the scoring engine 340 based on, for example, the frequency with which a word occurs in a given interest profile (e.g., by the frequency and weight analyzer) and any associated weighting of the occurred word inside the interest profile (how interesting is that to the user or the query being made which is represented by the interest profile). In some instances, more than two occurrences or more can progressively increase the score.

In one embodiment, the scoring engine 340 modifies or determines the relevancy score based on any reposts (e.g., via the repost analyzer 342). For example, the repost analyzer 342 can compute or otherwise determine the number of times a given post or message occurred in other messages coming from connections or friends relevant to a given context (e.g., people in a certain user group, people with certain interest, people connected/friends with a given user, etc.). In order to compute the score based on reposts, the number of similar messages can be determined. However, in general, when users repost a message, they often modify the original message to make it fit within a certain character limit. Therefore simply finding messages with the same text might yield poor results since exact messages will only be found in limited numbers.

As such, for a reposted message R, a search needs to be done across all stored messages M. If there is a match, the Repost Score can be incremented and a similarity link can be stored by the repost scoring engine. In one embodiment, this can be performed by retrieving all stored messages M and compare each M to R and identifying the M that had the most words in the sentence that matched. In another embodiment, a database full-text ‘OR search’ can be performed with all words in the sentence of R. Then, rank the results according to the number of keywords that matched and select the top matching results as similar messages.

In one embodiment, for a reposted message R, a natural language processing tool can be used to extract words, keywords, symbols, and/or tokens for that message. The words/keywords can include, but are not limited to: Nouns, Proper Nouns and Adjectives; the tokens include, but are not limited to: URLs, hashtags, user names, emoticons or other symbols. The repost analyzer 342 can then sorted and packed the tokens and/or keywords/words together into a repost index RI which can be generated for each message in M. The Repost Score can now be determined by performing a single database lookup on RI in M. Such a query is resource and time efficient since it is an exact match on a database field that can be indexed a second time via database queries.

In some instances, content source occurrence frequency can also be factored in (e.g., determined by the source occurrence counter 343) to compute the score. For example, one message/piece of content may be more relevant if it is also from a source (e.g., as identified by a URL/URI) with some determined prior relevance to a context (e.g., a specific set of users, a topic, etc.). The score can be increased if the source is frequently occurring. The source occurrence counter 343 can compute how many times the URL in a message occurred in messages relevant to a given context (e.g., from friends or connections of a given user or people that the user is following, etc.).

One application of concept/idea/theme detection and trend identification is personalization of a message stream for a user. In one embodiment, personalized message streams can be created by filtering/prioritizing various messages for the user by the information stream personalization engine 355. The personalization engine 355 can use a score generated by the scoring engine 340 to determine relevance to a user, interest to a given user, based on any specified criteria (e.g., within sports news, tech news, within the last week, etc.). Based on the score with respect to any facet or context, the messages can be filtered by the filtering engine 356 and prioritized by the engine 357 such that a personalized/customized stream of messages can be created and presented to a user.

In one embodiment, one example of a personalized/customized stream of messages for a user is a “likestream,” or a stream of messages/content that the user likes or might like, determined by explicit preferences or implicit preferences. For example, the host server 300 can provide a mechanism by which users may explicitly or implicitly “like” particular messages or people. By “liking” something a user explicitly tells the application that it is of interest. The host 300 (e.g., the personalization engine 355) then assembles a directory of the things the user likes. Within this directory, each faceted view, can be referred to as a “likestream” of things (e.g., messages, audio content, video content or any other content) that are liked by some set of users (such as a single user or even a community or group, such as people within an organization).

For each user x, a faceted directory hierarchy can be generated dynamically that contains all their implicitly or explicitly liked messages and/or people. This directory includes sub-directories, each itself a likestream, for various semantic types of messages liked by user x. For example, a typical likestream directory can include, one or more of:

All liked items by user x;

Videos liked by user x;

Audio liked by user x;

News liked by user x;

Products liked by user x;

Services liked by user x;

Applications liked by user x;

Photos liked by user x;

Quotations liked by user x;

Opinions liked by user x;

People liked by user x;

Ideas/concepts liked by user x;

<other type> liked by user x.

Implicitly liked messages for user x may include any/all messages that user x has authored, replied to, reposted, saved, or shared. User x may also explicitly liked messages or people by taking an action to “like” them in the application. In one embodiment, rating scales for likes can be provided such that users can indicate the degree to which they dislike or like an item.

In one embodiment, Likestreams can be subscribed to by other users who are subscribers of the host service 300 or users of other platforms (e.g., users of other social media networks). For example, when user x views the likestream for user y it is possible for them to subscribe to it as a stream or interest. By subscribing to a likestream, it appears as a stream (with a corresponding editable rule definition) in user x's main dashboard, alongside other streams they can track (generated by other rule definitions). User x may opt to subscribe to user y's top-level root likestream or they can navigate directory facets to reach sub-level likestreams that match a specific patterns (for example, a likestream of only the videos, or only the news articles, that user y likes).

In one embodiment, Likestreams enable users to follow facets of people they are interested instead of everything those people post. This enables users to filter their message streams for only the kinds of messages they want from various people. When adding a likestream for another user y, user x automatically follows user y so that they can get their messages, although in a variation of this feature it is also possible to subscribe to a likestream without following the originator of the likestream.

In addition, Likestreams can also be browsed and searched, both by their owners and by anyone with permission to view them, and in such capacity they provide a means to aggregate and discover knowledge. Messages may have specific permissions associated with them which govern which users may take which actions on the message including, for example:
Read
Write
Edit
Delete
Share
Annotate
Change permissions
Rank, score, prioritize

In one embodiment, likestreams can also be generated for sets of people, such as groups, lists, or communities of people. For example, a likestream, or any customized/personalized stream of messages could be generated for the set of all people a user follows, or just for all people tagged as “friends” or “family.” A likestream can also be generated for all people who share specific attributes such as interests, relevance to specific topics, geolocations, or affiliations. In one embodiment, a likestream can also be generated for all members of the hosted service 300, or for all members of any social network. In general, likestreams can display messages chronologically and/or ranked by the degree to which they are liked and/or the number of people who like them.

The user interface engine 350 can customize the presentation of messages or content based on a given context with may be user or administrator specified. For example, the user interface can present topics or trend relating to ‘tech news’ or ‘elections.’ The user interface can also be configured to present messages/content in a personalized manner based on implicit and/or explicit user interests and/or preferences. In one embodiment, the visualization engine 351 creates a graphical visualization of concepts or topics contained in the messages/content based on a given facet (e.g., the context may be topic/concept driven, user driven, location driven, platform driven, or based on any other facet), with each concept or topic is represented by a label which is arranged radially from a node (e.g., as generated by the interactive concept view generator). Around this facet (represented by the common node), there are connected topics, keywords and tags all of which are relevant to that facet in a certain configurable/specifiable timeframe (minutes, days, weeks).

The graphical visualization can be interactive, where, responsive to detection of selection or activation of the label, information related to the represented concept or topic can be further depicted in the graphical visualization. The user interface engine 350 can also update the graphical visualization continuously or periodically (e.g., in real time or near real time) such that the depicted trends/popularity or relevance levels to various facets/users are current. The graphical visualization can also be manipulated to plot and depict past trends at or around a certain time or within a past time period. In general, each node has a different visual style (color, edge thickness, etc.) which is based on how interesting and relevant the node is to a facet or a user (when creating a personalized graph of concepts for a user). When clicking a node, it will show related topics, tags and keywords and it will display related messages/content in a new window or side panel.

In one embodiment, the host server 300 can provide mechanisms to reward users for certain social media behaviors and achievements.

Rewards can be provided in many forms—virtual currency such as points for use in the services hosted by server 300, facebook credits, etc., coupons or gift cards, physical goods and services, or physical currency, or in the form of digital achievement badges, or increases in a user's status, visibility, influence or relevance to others in the hosted network and/or any other networks.

Rewards can be provided for achievements such as:
Getting n followers
Recruiting n new users to bottlenose
Sending n messages
Liking n messages
Annotating n messages
Getting n likes on a message from others
Getting n likes in total from others
Getting n likes on their user profiles from others
Getting n replies on a message
Making n replies to other users
Getting n reposts on a message
Getting n views on a message
Getting n clicks on a URL in a message
Getting n views on their profile page
Getting n followers for a particular likestream of theirs
Achieving an expertise rank of n on a topic or interest
Achieving influence rank of n
Detecting and reporting spam or abuse
Rating content or users of the system
Adding plug-in to the system
Getting n downloads of a plug-in they added
Getting n likes on a plug-in they added

In addition to gaining points, users may also lose points if they do things that are considered unwanted or harmful to the system, such as:
Adding content that is rated as spam or abuse by other members
Miscategorizing content when annotating it

The host server 300 represents any one or a portion of the functions described for the modules. The host server 300 can include additional or less modules. More or less functions can be included, in whole or in part, without deviating from the novel art of the disclosure. The repositories 318, 320, 322, 324, 326 and 328 were discussed in conjunction with the description of FIG. 1.

FIG. 3B depicts an example block diagram of the user assistance engine 360 in the host server able to perform various customized actions on messages including actions to personalize and/or filter messages for users.

The user assistance engine 360 can further include a semantic rule manager 361, an annotation manager 364, a recommendation engine 368, a machine learning engine 370, a social influence enhancement engine 375 and/or a subscription manager.

The semantic rule manager 361 provides a rules interface, and engine, to manage, create, implement, revise, and/or optimize the rules which facilitate customized, application-specific, user-specific, use-specific manipulation, processing, retrieval, filtering, prioritizing of messages and any content in a given network, across networks, or across any number of different online media sites or platforms. The rules can be defined by a user, by a platform, a media site, the host server 300, a platform partnering with the host 300, an organization or any other consumer or business entity. In one embodiment, the rule set is specified by the user or other types of entities, via a user interface provided by the service which is independent of the online or web based media services. Based on the set of rules, the manager 361 can cause the server 300 to perform an action on an incoming message in accordance with a rule set to process the incoming messages. One example of an action is the likestream comprised of messages implicitly or explicitly liked by the user as defined by the rule set described in the example of FIG. 3A.

The rules managed and tracked by the manager 361 can be defined to perform actions on messages/content based on one or more specified criteria. The rules can be defined or specified by the rules definition engine 362 and can include application actions such as annotating a message, reposting a message, notifying a user, making a recommendation to a user, launching another application, presenting with increased or decreased visibility or taking some other action. In some instances, the rules are automatically determined by default or automatically created by observing and learning system or user behavior (e.g., by the rules learning engine), as will be further described with reference to the machine learning engine 370.

The criteria can also be specified, defined, tracked or updated/revised by the rules definition engine 362 and can include, by way of example not limitation, if messages is received/acted upon via one or more of the following services, and/or message was (any or all) of (posted, replied to, reposted, received, liked, annotated, read, saved, tagged, etc.) by (any or all) of (one or more specific people, people I follow, people who follow me, people who follow some person, people with Klout score >x, people near some geographic place, people checked into some present activity, members of a list, any bottlenose user, people who have some attribute, people who do not have some attribute, or any person, etc. In general, the rules and criteria may take many features of messages, actions, and relationships, and any combination of the above into account.

The rule sets can be created and applied to create robots or assistance which can identify and customize message/content streams for any application, setting, context, or facet. An example table showing example rules sets to configure these assistants is illustrated in the example of FIG. 4C.

One feature of the host server 300 is the ability to support machine learning, creation, generation of rules of the ma chine learning engine 370 from observing, tracking, identifying, detecting, revising, and updating explicit and/or implicit user preferences/feedback from user specifications and/or behavior (e.g., by the user behavior analyzer).

Many learning rules are possible within the application framework, including by way of example but not limitation:
By analyzing user annotations, the machine learning engine 370 or the annotation learning engine 367 can infer and optimize rules that learn to automate user annotations in the future, and that learn to repost messages on behalf of a user.
Rules relating to people by adding people to a given user's interests or as being relevant to any given facet: The user behavior engine 371 can for instance, determine how much a user X interacts with user Y—for example by measuring how often they interact in one or both directions via replies, mentions, direct private messages, and reposts, or how often they “like” messages by one another, or click on links in messages that are posted by one another. When user X is measured to interact with user Y above a quantitative or qualitative threshold, recommend that user X adds user Y as an interest (interest stream and/or relationship), or automatically add user Y as an interest (which may be a function of yet a higher threshold or the same threshold).
Rules relating to site or content by adding sites to a user's interests or as being relevant to any given facet: The user behavior analyzer 371 can detect sites that a user X cites a lot in their outgoing messages, reposts, mentions, replies, or “likes,” can automatically become interests, or can be recommended to be added as interests for user. Once added as an interest, any messages that are received that cite URLs in sites of interest may then have a higher personalization score for user X or any other specified context/facet automatically.
Add a message to as an interest (via explicit learning) to a user or relevant to a facet: For a given message, a user can add it to their interests manually—they can specify what they want to add (the author, the content, particular topics, everything). The machine learning engine 370 can add the person who made the message automatically (even if the user doesn't follow them yet), as well as relevant keywords or patterns in the message such as the URL and tags etc. By adding to their interests in this manner, the engine 370 learns they are interested in this pattern such that future messages which are received and match the interest will receive a higher personalization score for the user. Similar process can be performed for facets/applications other than specific users, to identify relevant content based on key words, patterns or other criteria.
Ignore messages: The machine learning engine 370 can learn to automatically filter out or ignore messages that match certain patterns such that spam, offensive content, or all content from a specific party can be screened out for a user or for any specific application/context/facet.
Boost messages: The machine learning engine 370 can also learn to automatically boost the visibility or personalization score of messages that are more likely to be relevant to a user or any other given facet/context. In the case of a user, if a user X likes a lot of messages by some author Y, then the engine 370 can learn to make all messages by that author Y more important for user X. Similarly, the engine 370 can learn to boost the personalization score of messages that match various other patterns such as having specific attributes or being relevant to specific interests.

In addition, through the host server 300, anyone can mark any message as having any semantic type or attributes. This may eventually result in some percentage of miscategorized messages. The server 300 may be configured to leverage collaborative filtering in order to curate messages, and detect and filter out errors (e.g., via the collaborative curator 372 of the machine learning engine 370).

One example method for collaborative filtering is as follows:

1. When user a marks item P as type x, then it shows up as type x for that user only no matter what (even if other people disagree).

2. Types added to item by the item's author are innocent until proven guilty: They automatically show up for the crowd until and unless >n non-authors of item subsequently disagree by unmarking type x from item. If the item is unmarked by the crowd, then x doesn't show up on item for anyone other than author anymore. In other words, the author's types show up for everyone, but are removed for everyone other than the author, if enough people disagree.

3. Types added to item by non-authors of item are guilty-until-proven innocent. If >m non-authors of item mark item as type x, then x shows up for everyone. In other words, there must be some agreement before an item will show up as type x, for people other than the person who marks it as x. One exception is of course if the author marks the item as x—in which case see (2).

4. The variables n and m (the thresholds for “disagreement” and “agreement”) can be changed dynamically to adjust the curation thresholds.

Another aspect of machine learning or learning from the user crowd is leveraging message annotations by users (e.g., via the annotation manager 364). For example, if a user shares a message with a URL to the Youtube website, the server 300 can, based on various analysis techniques determine that the message is associated with a video. In some instances, the user can be queried to assist in determining what a message relates to. For example, the host server 300 (e.g., via the annotation manager 364) can query a user when it is posting a new message, reposting an existing message, liking an existing message, or otherwise acting on some message or content.

Once the message has one or more types associated with it (as tracked by the annotation tracking engine 365), the server 300 now has the ability to better provide better filtering of that message or related/similar messages/content all other users. For example if user A and user B have a filter specified for receiving messages that are marked as “News”, there could be a message M that has no type associated with it. When user A likes the message and assigns the type “News” to it, then the message will be filtered as “News” for both user A and user B.

In addition to enabling manual annotation of messages/content by users, rules can be generated which are capable of automatically annotating messages (e.g., by the auto-annotator 366) with metadata when the messages match specific patterns—such as originating from specific URLs or URL fragments, containing specific keywords, being posted or authored by specific parties, containing specific strings.

In addition, by analyzing sets of manually annotated messages, new annotation rules can be automatically derived and optimized over time (e.g., by the annotation learning engine 367), that generalize from collective annotation behavior. For example, if a community of users consistently annotate messages containing pattern x as being of semantic type y, then a rule can learn to make such an annotation automatically when a high enough degree of evidence is accumulated to have sufficient confidence in what has been learned.

In one embodiment, the host server 300 includes the ability to recommend online actions (e.g., including identification of online messages/content) that facilitates enhancement of social influence by a user or any other entity (e.g., business entity, organization, application, idea, concept, or theme). In one embodiment, the host server 300 through the social influence enhancement engine 375 can add an additional indicator (e.g., an influence weight indicator) to detected, tracked, stored, and/or analyzed messages/content. This weighting or indicator resulting in an overview identifying messages/content that can be reposted by the user (or some other physical entity such as a corporation or physical entity representing some ideology) to gain more network influence. The social influence enhancement engine 375 can also recommend certain actions in addition to posting/reposting messages (e.g., liking posts, friending certain people or entities, commenting on certain messages/content) which can also result in enhancement of social influence of a user or entity.

In one embodiment, the engine 375 computes the weighting by looking at the strength of a friend connection and the number of friends of that friend. Also, more sophisticated influence information is gathered by integrating with influence metric services like Klout.com. By measuring the relevance of a message to the interests of a user's followers an algorithm can determine whether the message should be reposted. By measuring historical diffusion of similar messages in a social network, the algorithm may estimate to what degree a particular message might spread further, via a person's followers, and may also recommend what times of day it should be posted in order to attain the maximum attention and spread.

In one embodiment, the server 300 provides auto-reposting capabilities for messages/content (e.g., via the auto-reposting engine 377) based on conditions or criteria that is user configured, auto-configured, or determined by any other third party services/interests.

For example, the auto-reposting engine 377 can provide a variation of Auto-RP in where certain messages are recommended for repost. The user or some other entity can then decide to repost the message or dismiss it. The criteria for auto-reposting or recommending a message/piece of content for repost, or for recommending that some other action be performed, can be based on multiple scores. These can include by way of example but not limitation:
Repost Score (see above)
URL Score (see above)
Frequency of interactions with the user that posted the message
An automatically learned weighting of previous interactions with similar messages
Explicitly user defined matches
The level of influence (such as Klout score) of the author of the message
The strength of relationship between the user and the author of the message (determined for example by the number of times the user has reposted, direct messaged, mentioned, or replied to the author, and/or the number of times the author has reposted, direct messaged, mentioned, or replied to the user.
The number of people who the user follows, who also follow the author of the message—a measure of similarity between the user's interests and the interests of the author.
The degree to which followers of the user may be interested in the author's message, determined for example by measuring the relevance of the message to each of the user's followers.

Formulas that include the above criteria and/or others, can generate a cumulative score for the message/content, or some other related action with respect to a network activity on a media site. A threshold may be defined such that if the score crosses the threshold, then a recommendation to repost a message is made. Users may opt to configure the auto-repost engine 377 to repost qualifying messages automatically, or to simply recommend them so that they can choose to repost them manually.

In one embodiment, the auto-reposting engine 377 can learn reposting rules for specific users or entities or other contexts, for example, by analyzing which messages they have reposted in the past in order to develop statistical models and/or pattern rules that can infer when to repost a new message. For example, if a user x has often reposted messages by another user y in the past, then the probability weight that they should repost any new message by user y in the future is increased. Similarly, by analyzing the features of such messages, the times of day, and the social relationships between user x and y, the precision of such rules can be adjusted and further optimized.

One embodiment of the host server 300 further includes a friend casting engine 378 which provides a default ‘Friendcasting Assistant’. This assistant allows a user x to specify rules that will automatically repost a message from another user under certain conditions. For example, a user x can define that all messages that match a pattern y (such as having a certain hashtag like, ‘#cast’, @ tag, + tag, and/or containing certain keywords or strings or URLs, and/or originating from a user u that matches whitelist W) will be automatically reposted by user x. This enables people to request that their friends repost particular messages by simply attaching the appropriate hash tag (such as #cast) or @ tag, or other tags to their messages, instead of having to make a direct request for a repost via a message to each person.

The recommendation engine 368 can, using the output of the annotation manger 264, the machine learning engine 370, and/or the influence enhancement engine 375 and make the appropriate recommendations to a user, entity, or any other party or representative accessing the services/features of the host server 300. The recommendations can include rule/action sets defining assistants which are use, application, context, and/or user specific, recommended or suggested annotations based on observation of system and/or user actions/behaviors, recommendations of actions including posts/comments/reposts of content/messages which may enhance social influence of a user or any entity/party/representative, concept, theme, organization.

FIG. 3C depicts an example block diagram of the content targeting engine 380 of the host server 300 able to recommend ad or placement of other promotional content based on trends identified from the analysis of activities occurring in or across networks.

The content targeting engine can further include a targeted content analyzer 381, an online identity generator 382, a trend detection and prediction engine 385, a profile enhancement engine 383, and/or a content placement engine 384. Additional or less components can be included in the host server 300 and each illustrated component.

The platform hosted by the server 300 can in some embodiments, additional provide targeting content (e.g., advertisements, coupons, ideas or other promotional content) to users of a client application, or other application that use platform's API, or other applications otherwise in communication with the server 300 and/or its visitors/users. Promotional content (e.g., advertisements) can be targeted to users based on a number of methods:

Targeting to user interest profiles (e.g., which can be used by the online identify generator 382 to generate an online identify for a user)—each user has a rich interest profile generated by the host server 300. This profile can include statistics about many dimensions (e.g., generated by the analytics generator) of the user, for example: their interests, their social relationships, the degree to which they trust other people on various topics, the degree to which other people trust them on various topics, their social influence, their demographics, the sites they are interested in, the content and products they are interested in, statistics about the people they repost or reply to or who repost or reply to them, the people they are interested in, their present geo-location and path, as well as other locations they are interested in, etc.

Their online activity including information regarding, various types of content they are interested in (videos, audio, questions, classified ads, etc.), their usage behavior with respect to the platform hosted by server 300 (how often the login, stats about their messaging activity, various analytics of their usage activity to derive trends (e.g., by the trend detection and prediction engine 385) about when they are active and what gets them to take various actions in the application such as clicking an ad or reposting a message, etc.), trends in their interests (such as which interests are gaining or decline with what momentum) and trends in their social relationships (such as which people they interact with more, read more, repost more, reply to more, pay attention to more).

Profile information can be determined by the online identify generator 382 from existing user profiles of the user on the Web, as well as from profile information that is manually contributed by other users, as well as information that is derived through data mining, analytics and machine learning of user behavior by the platform hosted by server 300 (e.g., the analytics generator) and any other networks such as media networks and/or social networks (such as Twitter and Facebook).

Note that the trend detection and prediction engine 385 can identify past trends and current trends from any set of messages/activity occurring in one network (e.g., one social media network) or across multiple networks (e.g., multiple social media networks). The trends that are detected or identified need not be for a specific user, but can be for a group of users or based on some other context. For example, trends in sports news, or trends in the economy, or trends/what's popular in the SF bay area, or trends in Europe, or what's popular among Facebook users in India, can be detected and identified. The promoter/advertiser can specify the facet with which to view analytics to identify ideal targets for the promoted content.

In addition, emerging or upcoming trends, such as a prediction of trends can also be performed by the trend detection and prediction engine 385. For example, upcoming or emerging popular topics/concepts/figures can be detected versus topics/concepts/figures which are generally popular (e.g., steady state). For example, in the context of NBA, the figure ‘Jeremy Lin’ can be detected as an emerging popular trend of a recent few weeks where as ‘Kobe Bryant’ can be identified as a generally trendy topic for several years among NBA fans or sports news.

With placement, the content placement engine 384 can overlay content among message/content streams in the platform hosted by the server 300. The content can include content that is created within the platform of the host server 300, to other users the same platform or other platforms, or clients accessing the same platform (e.g., desktop application or a mobile application/client). The content that is placed based on user, activity, geolocation, UI placement, and/or timing targeting can also include third party content. In general, the Bottlenose content can include any kind of content (text, graphics, audio, video, animation, ads)

In general, the content placement engine 384 can place content anywhere in the platform or any other clients for accessing the platform—for example: on pages, screens or windows within the application; as messages or as blocks of content in the messaging area that behave like messages; in the banner, footer, or sides of the application window. The UI selection engine can identify the suitable placement within a page in a given user interface.

In one embodiment, the content can be automatically to external networks such as Twitter or Facebook. In some instances, it remains within the hosted platform but provided to third-party applications that request such information from the host server 300.

The targeted content analyzer 381 can analyze content on the fly, for example, when messages or content are shown to users via the hosted platform. The analyzer 381 can determine the relevant concepts and interests, and show any relevant promotional content in the user interface to the user, either via the web-based client, a desktop client, and/or a mobile client. The promotional content (e.g., either created within the platform of the host server 300 or whether it is third party content) can appear within the user interface in several ways: as banner or sidebar ads, adjacent to a message/content stream, next to or within search results in the hosted application or any other applications that obtains search results from the hosted platform, or directly within the stream of messages/messages depicted in the user interface, but appearing in a different manner, as can be determined by the content placement engine 384.

In one embodiment, by showing ads or other promotional content within the message/content stream, the host server 300 can also overlay its own ads on the message/content stream—such as a message stream of external social media (e.g., Twitter or Facebook) messages/activities/content—without altering the original message stream or posting any ads to the external services (e.g., in Facebook or Twitter platforms). In other words, the content targeting engine 380 can interleave the promotional content with the messages. For example, the interleaved content can look like specially formatted messages—but they are marked as ads.

For example, an ad from the host 300 can appear between two messages from other networks such as Twitter or Facebook. The promotional content/item can reside, in one embodiment, in the hosted platform and only shown and depicted to users of the hosted platform and not posted out to Twitter or Facebook as an actual message.

In one embodiment, the promoted content can be created as message annotations within streams (e.g., by the placement engine 384). For example, the engine 384 can make create words within messages/content (such as messages from Twitter) into hotlinks or hover-points. When a user either clicks on them or hovers over them, relevant information can be shown which may include advertising or marketing messages. In one embodiment, ads such as banners, ads that appear woven between messages, and annotations to message content, can be targeted to the content of the message(s) that area appearing to a user and/or to the specific user's profile information (e.g., via the user selection engine of the placement engine 384). In other words promotional content targeting can be based on message content or can be based on user-targeting, or both. In addition, targeting can further include location or timing factor considerations, for example, when factoring into trends or “what's hot/popular” as these categories can include a location or timing parameter, or both.

In one embodiment, the server 300 provides special “bots” (software agents) that perform tasks within hosted application as well as client applications. Bots are special type of the Assistant, as previously described with respect to the example of FIG. 3B. In one embodiment, bots are capable of monitoring what a specific user is sending messages about (such as what they are tweeting about), and then intelligently replying to the user with responses of various kinds (such as to provide relevant information, to ask the user relevant questions, to offer relevant advertising, to provide relevant advice, to give relevant feedback or praise to the user).

For example, an advertising bot can monitor what a user is talking about in platform, or external platforms, and if it notices that they have changed location and are asking about where to have lunch, it might then recommend places near the user's present location where they could have a lunch they would like. Or for example, when a user sends messages about a particular product or technical need, the bot could reply with an offer of competing products, or related coupons or special offers, or an offer for information related to the product or need, or could even connect a live sales agent with the user and enable the sales agent to reply to them right away.

In another example, a concierge bot could respond to simple questions and commands from users to get information or execute and complete certain tasks. If a user addressed the concierge bot with a private message containing such a request or command, the concierge can then go to work on the task for the user, and reply to them with questions or results. For example the concierge bot could respond to a user's request to book a flight, or book dinner reservations, or order a cab. It can interact conversationally with the user to ask further questions in order to complete the task, disambiguate what the user wants, narrow results, make choices or purchases on behalf of the user, or provide user information to other services when requested by them.

A concierge can also provide personalized recommendations or advice to users as they do things while using Bottlenose. This can include giving them either solicited or unsolicited suggestions, whether the user is actively engaging with the Bottlenose app or the app is idle. For example, if the user is actively using the app to read something or send messages or engage in a conversation the concierge can make relevant suggestions to what it sees them doing; but even if the user is not actively engaging—such as when passively walking down the street—for example, by detection of their location for example via their mobile device, then the concierge bot can make relevant suggestions to the user for their present location and possible activity or goals or interests at that location.

In one embodiment, the server 300 can generate the analytics (e.g, by the content analyzer 381 and the online identity generator 382) and provide analytics systems both to users of Bottlenose and marketers/advertisers. Analytics that are generated can provide high level as well as granular data and analysis about user behavior, usage trends, aggregate user behavior, search terms and search trends, overall interest trends (past trends, current trends, emerging or predicted trends), user value, user influence, user expertise, user response rates, etc.

In one embodiment, analytics which are generated by the server 300 can provide each user with a detailed report of how they are performing, and how each of their messages has performed in the platform hosted by server 300 as well as in other social media networks, that the host 300 can analyze.

In one embodiment, the targeting engine 380 can provide advertisers and marketers with analytics to help create and target campaigns to user segments (by interests, demographics, geography, user behavior statistics, time slots, industry or affiliations to organizations, political affiliations, sentiment on various topics, or relevance to clusters of attributes or particular topics). Analytics may also enable advertisers to measure and adjust the performance of a campaign in real time, manually or automatically, to optimize for specific advertiser-goals (such as get the most clicks, or reach the most people, or generate the most sales, etc.)

In one embodiment, the targeting engine 380 can annotate third-party user profiles (e.g., via the user profile enhancement engine 383) to add richer information to them, when they appear in the hosted application environment or on third-party clients or applications that show those profiles. Within the hosted platform, user profiles may display plug-ins, or may have new features provided by plug-ins. In addition, through the platform of the host server 300, users can add new tags to their profiles, as well as new fields, new metadata, and new data. Users can also customize the design of their profiles (adding their own HTML, CSS, layout or template, or specific design elements)

In one embodiment users can add custom content to their profiles, such as new sections of content, edit and modify their interest profiles—to add an interest, or modify their level of interest in a topic. In addition, user profiles or an online identify profile generated by the generator 382 can include visualizations of user social relationships, or provide analytics on their value to the network or their behavior, or their social statistics (such as growth in friends, change in influence, level of sentiment or trust about them from others, where they fit in the social graph, who they are related to, who they are similar to, etc.)

In one embodiment, profiles can provide as a mechanism to send a message to a person, where that message may be screened or may require a fee to send, or may be sent without restrictions. Messages sent to users via their profile pages may also be semantically tagged to be of a specific type, like any other Bottlenose messages.

In one embodiment, profiles can provide alerts to the people they represent and to people who visit and view these profiles. Alerts might include a notification that the user being viewed is presently geographically near to the user viewing the profile, or they might be notifications that the viewing user shares certain interests or friends with the user being viewed. In one embodiment, profiles can provide additional functionality for initiating various actions between the person they represent and the party viewing the profile (such as scheduling a meeting, or making a phone call, doing a video conference, providing an endorsement or requesting one, making a request or offer, or doing a transaction).

In one embodiment, profiles can provide different information to the party that owns the profile than to parties who don't own it and are just viewing it. The owner of a profile may be able to see analytics and statistics about themselves that are not visible to anyone else. In addition personalized and private services may be provided to the profile owner via their profile.

FIG. 3D depicts another example block diagram of the content targeting engine of FIG. 3C with additional or alternative details which can enable the content targeting engine to dynamically place, schedule, and adjust promotional items based on momentum of activities of a targeted audience in a network.

An embodiment of the content targeting engine 380 is shown in FIG. 3D to include, in addition or alternative to the modules and functionalities discussed with regard to FIG. 3C, a targeted audience selector 386, a value determination engine 387, and a performance measurement engine 388. The content targeting engine 380 also includes a trend detection and prediction engine 385 and a content placement engine 384, both of which are discussed above; however, as shown in FIG. 3D, each of the engines 384 and 385 includes additional or alternative modules that enable the content targeting engine 380 to dynamically place, schedule, and adjust promotional items based on momentum of activities of a targeted audience in a network.

As aforementioned, the present embodiments recognize that key word promotions or advertising is typically static and lacks responsiveness to the volatile nature of ever-changing topics and trends happening in various networks, online, social, cloud-based or other networked environments. It is further recognized by the present embodiments that the effectiveness of promotional items, especially for online or other web-based promotions in a media or network context, certain topics attract certain types or categories of audiences at particular time (e.g., during an event's happening such as an National Football League (NFL) game), and that the interest of the audiences to such topics can change as the event progresses or as other events arise. As such, there is a need for techniques to track, monitor, qualify, and/or quantify these user interests or changes in the interests, whether temporary, permanent, and/or over a certain amount of time.

In one embodiment, user interest, change in interest, digression of interest, digression of interest over a period of time, or rate of digression of interest over period of time can be characterized by or quantified using a factor referred to herein, for example, as a momentum of a topic. This factor can be, for instance, computed as a quantitative factor for use in tracking and monitoring a user's interest and change in interest and/or rate in change of interest. Based on the momentum of topics, the present embodiments can increase the effectiveness of web-based or network-based advertising and promotions. This factor can also be used in tracking a set of user or a group or an aggregate set of user's interest and/or rate of change of interest in a topic or related set of topics or concepts.

Accordingly, the content targeting engine 380 can enable the host server 300 to dynamically place, deliver and/or adjust targeted promotional content based on momentum monitoring, tracking and analysis. More specifically, in one or more embodiments, the targeted audience selector 386 can select a group of users from a user population in a network based. The selection can be based multiple factors, including a degree of association between (i) one or more key words as designated by the merchant client who assigns the promotional content/item (e.g., advertisement), and (ii) profile data or past activities from the user population. For example, a target audience for an advertisement, such as a promoted or featured message in a social network, can be selected by the targeted selector 386. The merchant client, for example, can choose a set of initial target topics or key words 386a.

Then, the targeted audience selector 386 can match the key words 386a with user data 386b to locate a particular set of the audience (or “targeted audience). The match can be based on demographics, psychographics, interest profiles, influence or engagement levels, including profile data (e.g., gender, interest, age, education, hobby, etc.) and past activities performed. As an example, if an advertising merchant client wants to reach an interested audience who are Americans and interested in the NFL, the key words 386a (e.g., location: USA; key word: NFL) can result a targeted audience which may be all people in the USA who post about or like NFL. Additional examples of the profile data or past activities can include posts, likes, interest profiles, demographics, psychographics, influence or engagement levels, or geographical regions.

After the targeted audience is selected by the targeted audience selector 386, the trend detection and prediction engine 385 includes the targeted audience activity tracker 385a which can monitor activities performed in the network by the group of targeted audience, and includes the topic identifier 385b which can identify one or more topics from the activities. In some embodiments, the trend detection and prediction engine 385 can employ a natural language engine (e.g., natural language processing engine 331) to parse text included in the activities for the identifying of topic. Examples of sources from which the engine 385 can detect topics can include nouns, noun phrases, links, usernames, tags, or concepts. Specifically, in accordance with some embodiments, the trend detection and prediction engine 385 can communicate with and/or give commands to the natural language processing engine 331 in the message analysis engine 330 (both of which are discussed above) to employ natural language processing on some or all messages communicated by the target audience identified by audience selector 386 (e.g., by matching key words with topics of interest and/or audience characteristics) and detect all the topics the activities. Examples of such activities include activities include one or more of: posts, tweets, status updates, likes, shares, replies, reading activities, or searches.

After the topic(s) is identified, the trend detection and prediction engine 385 can determine or compute the momentum for the topic. More specifically, the momentum determination module 385c can compute momentum of the topic or concept that is identified, for example, by the topic identifier 358b. In some embodiments, the momentum is proportional to (i) a number corresponding to how many users whose activities mention the topic and (ii) a frequency corresponding to how often the topic is mentioned (e.g., discussed, described, tagged, hash-tagged, tweeted, re-tweeted, indirectly mentioned for example, read, searched for, shared, liked, posted on to a given network, posted onto another network, posted onto a user's timeline, another user's timeline, etc.); for example, the momentum of each topic in a conversation, dialogue, message, or any stream of text can be computed by “mass” times “velocity,” where mass can, for example, represent the size of the crowd (e.g., number of users), and velocity can, for example, represent the frequency of a particular topic or concept is mentioned. It is noted that other suitable methods can also be adapted in addition or as an alternative to the above formula in calculating the momentum.

Then, the trend detection and prediction engine 385 can selectively deliver advertisements or promotional items/content to a selected or targeted group of users based on the momentum for the identified topic. More specifically, the content placement engine 384 can determine time 384a and location 384b of a promotional content/item (e.g., advertisement) is to be delivered to the group of targeted audience based on the aforementioned momentum of topics. In this way, the content targeting engine 380 enables the host server 300 to automatically deliver advertisements or promotional items or content with topics coherent or relevant to the interesting or high value momentums,

In one embodiment, momentum that is gaining or gaining quickly or gaining rapidly, or momentum having with a trajectory having a predictable to be of significance or relevant importance in the future so that the advertisements or promotional items or content can reach people who are currently paying attention to those topics. The present embodiments can therefore effectively improve the relevancy of the promotional content/item (e.g., advertisement) presented to the targeted audience, thereby increasing their performance such as click rates.

Some example locations 384b can include public timelines, user timelines, topic timelines, search timelines (e.g., search results), portal sections, or when viewing messages or external content, or any other suitable location where promotional content or items can appear in a social network, community or communications forum.

Additionally or alternatively, some embodiments of the momentum determination module 385c can filter for the topics that are “interesting,” or having “high value” momentums; for example, these momentums can be high momentums, momentums that are increasing, momentums that are gaining rapidly, or momentums with trajectories that projected to become large in the future, and so forth. More specifically, in some embodiments, the momentum determination module 385c can analyze a magnitude and a rate of growth for the momentum of the topic or concept over a period of time or a selected period of time.

In some embodiments, after the magnitude and the rate of growth of the momentum are analyzed, the momentum determination module 385c can assign a first grade to the magnitude of the momentum, and a second grade to the rate of growth of the momentum, in order to determine the “interesting momentums.” So, for example, “high momentums” can be momentums with magnitudes that exceeds a certain threshold, “medium momentums” can be momentums with magnitudes that falls in between a first threshold and a second threshold, and so forth. Similarly, “momentums that are increasing” can be momentums with rates of growth that are positive; “momentums that are gaining rapidly” can be momentums with rates of growth that exceed a threshold; “momentums with trajectories that projected to become large in the future” can be momentums with exponential growth rates.

The grades can be reflective, representative, qualitatively correspond to or be a quantitative indicator of how interesting or how valuable the identified topic is to a user or a group of users at a given instant, or for a period of time, in a certain context, for example. Additionally or alternatively, the momentum can also be computed in context free manner and without a temporal factor or period association. In some embodiments, the grades that are assigned to the magnitude or rate of growth of momentums can differentiate different levels of magnitude or rate or growth based on different thresholds; for example, different thresholds can be set to differentiate a low, medium, and high momentum. Similarly, different thresholds can be set to differentiate a slow, medium, and rapid growth rate of a momentum. In some embodiments, the grades that are assigned can at least categorically differentiate different types of growth, for example, whether the rate of growth is: (i) positive; (ii) exponentially positive; (iii) negative; or (iv) exponentially negative. Additionally, the momentum determination module 385c can differentiate other types of growth including, for example, hyperbolic or logarithmic growth, when assigning the grades.

Further, in some embodiments, the momentum for the topic can be determined based on momentum of a conversation (e.g., any one or more of, a dialogue, message, a text, any stream/combination of words, texts, etc.) which can be proportional to or computed from (i) how many users who participate in the conversation and (ii) how often the conversation is renewed by the users who participate therein.

Then, the momentum determination module 385c can calculate a weighted sum (or score) based on the grades and their respective categories; for example, in some situations where high growth rate or momentum with potential or high potential (e.g., having a trajectory or rate/growth rate predicted to be high or valuable at some point in the future) is valued more than a momentum that is already high, growth rate can have a higher weight than the magnitude when the momentum determination module 385c calculates the weighted sum. In this way, the momentum determination module 385c can identify high value topics as basis for scheduling delivery or adjusting the selective delivering based on a weighted sum of the first and second grades.

Optionally, the sentiment of each topic or concept can also be determined to add additional dimensions of data to the topic. For example, an attitude, thought, or judgment prompted by feeling as expressed by the word choices used by the users in the activities can be taken into momentum calculation or other consideration when evaluating trends of topics. More specifically, the momentum determination module 385c can employ a sentiment module 331a in the natural language processing engine 331 to analyze sentiments from wording used in the plurality of activities, and the momentum determination module 385c can adjust the momentum based on the sentiments.

For example, if sentiment is included as one of the basis for the momentum determination module 385c to determine momentum, the sentiment value of a topic can be used to further weight how interesting or how valuable the momentum of the topic is. The adjusting of the momentum can reflect a degree of positivity or negativity of the sentiments, for example, strongly positive wording, moderately positive, neutral, weakly positive, weakly negative, moderately negative, or strongly negative. Similar to the aforementioned grading, a weight can be given to the sentiments by the sentiment module 331a so that words with strong positivity can have a heavier weight in influencing the momentum adjustment than words with only slight or medium positivity or neutral. In this way, highly negative or positive sentiment, for example, can amplify the value of a topic negatively or positively.

In some embodiments, the content targeting engine 380 includes the value determination engine 387 which can determine a price (e.g., for merchant clients to bid) on each topic for promotional content/item (e.g., advertisement) in one or more social networks. Some embodiments of the value determination engine 387 can automatically determine a price for the selective delivery based on the above-discussed weighted sum of the first and second grades.

Moreover, some embodiments of the content targeting engine 380 includes the performance measurement engine 388 which can measure a performance of the delivered promotional content. An example of the performance can include click through rate, read through rate, tweet rate, re-tweet rate, viewing rate, post rate, or other performance measurements. The automatic selective delivering (e.g., the time 384a, the location 384b, etc., of the promotional content) can be adjusted by the content placement engine 384 based on results from the measuring (e.g., which may be communicated to/from the statistics extraction engine 315, discussed above).

By measuring performance on an advertisement or other promotional content, and feeding data back into the targeting algorithm for further targeting calculations and adjustments (e.g., as implemented in the trend detection and prediction engine 385 and content placement engine 384), the content targeting engine 380 can further improve its advertisement/promotional content targeting optimization.

For example, in some cases where although a particular term might be trending but not resulting in high engagement rate or performance, while another term which may be trending to a lesser degree but resulting in more engagement rate, adjustment to the delivery of the advertisements can be made by content placement engine 384 to reflect this phenomenon. Additionally, momentum determination module 385c can adjust the grades of the momentums based on the performance observed by the performance measurement engine 388. In this way, the present embodiments are able to measure the actual engagement for advertisements or promotional content or items so as to enable a better weighting of the relative value of particular terms for targeting particular audience.

Furthermore, some embodiments of the content targeting engine 380 includes a criteria module 384c to optimize use of a promotion budget for a campaign that runs over a period of time, or over several disjoint periods of times. Some of the campaign might also include more than one promotional content/item (e.g., advertisement) and/or more than one target audience. The present embodiments (e.g., the trend detection and prediction engine 385, the content placement engine 384, etc.) can continuously, in real time or near real time to repeatedly perform the advertisement targeting techniques disclosed herein to retarget/refine an advertisement campaign in order to optimize goals for a particular budget, time period(s), and/or audience(s). For example, the above-mentioned activity monitoring, identifying of topic, determining of momentum, and the selective delivering steps can be repeatedly performed per select period of time, such as every ten minutes.

It is noted that, for simplicity, some of the present embodiments are described in a social network setting. However, the techniques disclosed herein can be used to target advertisements or promotional content outside of social networks. For example, conversations, likes, shares, posts, tweets, re-tweets, dialogues, and/or any other actions in social networks or any other suitable network (e.g., email systems, discussion forums, portal websites, mobile applications, SMS messages, mobile environment, gaming environment, or search engines) of users can be measured to determine the momentum of attention around a target audience. Then, that targeting data can be used to target promotional items or content such as advertisements to reach that audience on websites or search engines or portals in real time or near real time, which are examples of applications outside of a social network.

At some frequency, such as every minute, the present embodiments of the content targeting engine 380 can re-compute and update the targeting for the advertisement or promotional content placement. In this manner, the targeting for the advertisement dynamically follows the trends that attracts attention (e.g., based on interests, conversation, etc.) from the intended audience for the advertisement. For example, during an NFL game, various terms can gain and lose momentum in spikes as the game plays out; or if other events occur during an NFL game, for example during halftime, a specific half time performance by a specific halftime performer, or during a specific half time advertisement.

As a particular example, when a player X makes a touchdown, topics about that player and the team can “trend” or gain momentum. Then, when player Y is tackled or makes a great play, momentum of topics about player Y and his team and/or city can suddenly spike. By detecting these trends of momentums in real-time or near real time, and by dynamically retargeting a promotional content/item (e.g., advertisement) to follow these momentums, the advertisement can get overall more attention because, from the perspectives of the targeted audience, the advertisement almost always appears around every spiking term to which the advertisement is related. The techniques disclosed herein can largely increase the advertisement's relevancy, thereby resulting in the advertisement having more chances to get seen and get higher performance (e.g., shared, liked, clicked on, etc.).

In some embodiments, the content targeting engine 380 can also suggest potential topics to a human for approval before adding them to the ad targeting. Optionally also suggest sets of topics together that reach the best possible audience. Optionally suggest sets of topics together that reach the best possible audience for the least cost, or for some other criteria.

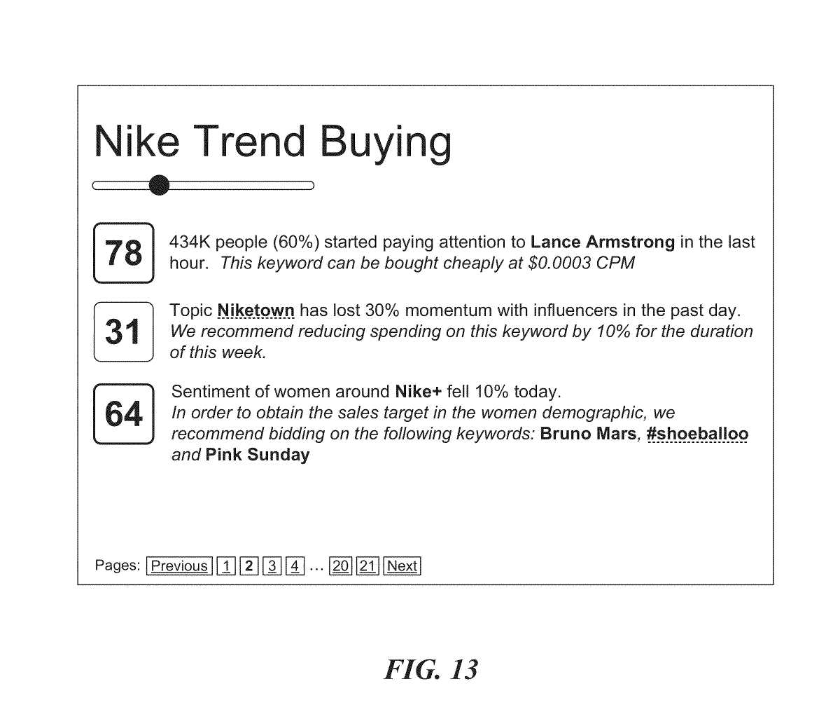

Further, in some embodiments, the trend detection and prediction engine 385 can suggest, to an administrator, potential topics for the potential topics to be added into the key words. In some embodiments, the trend detection and prediction engine 385 can suggest, to an administrator, sets of topics to be grouped together to adjust the selective delivering. In some embodiments, the trend detection and prediction engine 385 can suggest, to an administrator, sets of topics to adjust the selective delivering based on a cost of the promotional content. An example interface which the host server 300 can automatically generate in suggesting trend, momentum, key words and possible grouping thereof, to an administrator is depicted in FIG. 13. As shown in FIG. 13, the example interface can show, for example, how many people started to pay attention to what key word, and in some embodiments, the host server 300 can automatically determine how valuable the key word is worth. Similarly, the host server 300 can suggest reduce spending budget on key words that lost their momentum, which may be temporarily or for a period of time, also optionally determined by the host server 300. These suggestions can be generally generated or for a particular merchant client such as “Nike,” which may have its own set of key words so that the host server 300 can detect and generate other key words that may be relevant and valuable to the merchant. As shown in FIG. 13, group bidding on a set of key words can also be recommended by the host server 300.

In this way, the disclosed techniques are able to continuously update and optimize the targeting of a promotional content, or promotion campaign (e.g., a series of promotion content/items/advertisements over a period of time), or other promotional content in a social network, based on real-time measurement of trends (e.g., momentum of topics) in a social network.

FIG. 3E depicts an example block diagram of the trend detection and prediction engine of FIG. 3C which can predict momentum of topics in automatically optimizing placement of promotional items in a network.

An embodiment of the trend detection and prediction engine 385 is shown in FIG. 3E to include, in addition or alternative to the modules and functionalities discussed with regard to FIG. 3D, a momentum prediction module 385d, which may further include a momentum vector calculator 381d-1 and a momentum monitor 381b-2.

According to some embodiments, the momentum prediction module 385d can enable the trend detection and prediction engine 385 to predict near-future or future momentum, and to predict the dynamics or changes over time for those identified topics, and/or for any other topic that is around the identified topic by measuring the momentums over time of particular topics. More specifically, the momentum prediction module 385d can predict a future momentum for the identified topic based on observing additional topics which are related to the identified topic and have momentums with a rate of growth that exceeds a positive or negative threshold. For example, given a starting topic X, one or more embodiments of the momentum prediction module 385d can detect multiple topics around topic X with interesting momentums. Then, the momentum prediction module 385d can predict which ones will gain in momentum, continue to maintain high momentum, or decline in momentum in the near-future.

In some embodiments, the momentum vector calculator 381d-1 can compute a momentum vector for each identified topics over a select period of time. The momentum vector can comprise a line formed by tracing a magnitude of the momentum for a given topic over the select period of time. The future momentum can be predicted based on a proximate direction of the line. In one embodiment, the momentum vector calculator 381d-1 compute a momentum vector every N units of time for each identified topic.

Thereafter, over several units of time (as monitored by the momentum monitor 381b-2), a pattern can emerge where the momentum vectors connect to form a line in momentum space (e.g., which can be represented by a two-dimensional plot of mass times velocity). This line can indicate a direction or path of momentum for that topic. Then, the momentum prediction module 385d can detect emerging topics with interesting momentums as well as to detect changes in the direction of momentum for large trends.

The content targeting engine 380 can then adjust, modify, or refine the placement of promotional content (e.g., promotional item such as an advertisement or a coupon) and/or momentum of topic calculation based on the outcome of the prediction from the momentum prediction module 385d. So, as one specific example, the host server 300 can perform trend prediction by performing:
Take time series data points over time about a particular metric (volume, impressions, sentiment, etc.) to form a timeline;
Perform Gaussian filtering on this timeline;
Perform a Discrete Fourier Transform (DFT) projection of the timeline;
Use Decision Tree, K-means and Support Vector Machine (SVM) decision makers to determine whether there was a trend or not; and
If a trend was detected, a new recommendation can be made.

Similar to the aforementioned techniques, the host server 300 can perform momentum monitoring and prediction continuously for a select number or all topics that are available. So if, for example, a hashtag “#hello” appears in a stream, data metrics associated with it can accumulate over time (e.g., how many positive #hello? How many female #hello? How many #hello in Africa? etc.). For one toppic like #hello, many different numbers can be generated/gathered by the host server 300 over time.

FIG. 4A illustrates an example entry 400 in a user analytics repository. An example entry 400 can include a user identifier 402 (user name, real name, logon name), demographic information including age 404 and/or other information, an identification of registered media sites 406, influence score of the user 408, for example. The entry can also include the interest profile 410 of the user represented by a list of topics/concepts which can include ideas, products, services, people, sites, or any other entities. In one embodiment, the list of topics/concepts can be weighted to indicate relative level of interest of the user in each of the represented topics/concepts.

FIG. 4B illustrates an example entry 430 in a message analytics repository. The example entry 430 can include, an identification of the message 432, the action type 434 relating to the message, the user who acted on the message 436, an identification of the media platform 438 through which the action was generated, an original content source 440, and/or the analytics 442 associated with the message 432. The analytics can include, for example, metadata, annotations, URL metadata (metadata from cnn.com), and/or an identification of similar messages with may represent reposts. The analytics can be derived or generated by the host system shown in the example of FIGS. 3A-3B. The analytics can also be derived or generated by hosted components residing on the client side, or in any part contributed by end users, consumers, or other third party entities.

FIG. 4C illustrates a table 450 showing various configuration settings in a semantic rules set.

The semantic rule set can be specified to configure assistants to customize media content/messages or activities from one or more media sources (e.g., social media sites or platforms) to be optimally presented for various applications. For example, one assistant can be configured to aggregate and show all posts across multiple media sites by a popular figure (e.g., Mitt Romney), one assistance can be configured to show all posts on Twitter relating to an entity (e.g., the Boston Celtics, or the World Trade Center site) in a given time frame, assistants can also be configured to filter and show content relating to certain users or posted/acted on by certain users (e.g., select users who are members of a group or certain select users that specified according to some other criteria).

Multiple assistants can be created from different rule sets such that multiple content or message streams are generated for different applications. Each rule set can implement one or a combination of conditions (e.g., as shown in sets 452, 454 an 465), and when the condition(s) are met, any number of the actions x 458 can be performed.

The action x can include, for example, any number of such actions as: show me the message in a particular view or stream, adjust the relevance or visibility of the message, play a specific sound, alert me by email, alert me by SMS, generate a desktop alert, highlight the message, automatically annotate or tag the message, repost the message, delete the message, hide the message, file the message, reply to the message, translate the message, change the personalization score of the message, save the message, add the message to my interests, add the author of the message to my interests, share the message, launch a plug-in or another application, call a function, send the message to another application, export the message as data, view the message in a specific viewer, learn something from the message, etc.

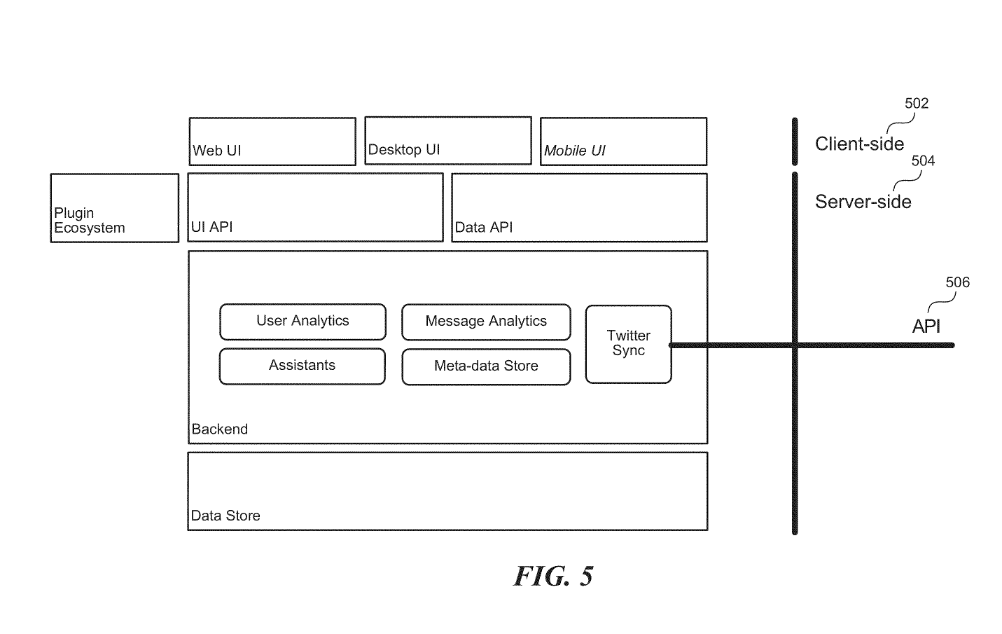

FIG. 5 illustrates an example architecture of a system which analyzes messages in a network or across networks to/from various online media sites and/or users.

The system can include client-side 502 components and/or server-side components 504. The client-side components 502 which can include a single client device or multiple client devices (e.g., a single laptop or multiple laptops/servers/computers/phones/tablets or other computing devices). The client-side components 502 can also include one or more of multiple clients (e.g., the web-client, a desktop client, and/or a mobile client).

In one embodiment, a client device in the client side 502 components can determine, from the set of messages, commonly or frequently occurring topics. The client device includes an end user device such as a laptop, computer or mobile computing device (mobile phone, tablet, etc.) on the client side 502 of the architecture. The client device on the client side 502 can, for example, computes at least a portion (e.g., some or all) of the analytics for the commonly or frequently occurring topics in the set of messages that indicate respective levels of popularity which are then presented as indicators at the client device (e.g., via the user interface component) in a graphical arrangement which depends on the respective levels of popularity (via the client device). The client-side components 502 can include a user interface component which is also able to depict incoming messages/content in a stream personalized for the user with the visibility of those messages which are more interesting enhanced.

Furthermore, the components shown on the server-side 504 (e.g., user analytics, message analytics, assistants, etc.) can in addition reside on the client side 502. As such, the server-side components 504 may not be needed. In some instances, other portions of the analytics used to determine the respective levels of trendiness of the commonly or frequently occurring topics is computed by other client devices (e.g., other devices, laptops, smartphones, or tablets on the client side 502), such that the computing load can be distributed across devices. By using multiple client devices to compute analytics the processing power can be increased. The client device can then with the other client devices to obtain the other portions of the analytics used to present the indicators at the client device.

In one embodiment, crowd-based cloud computing is implemented in that the processing is performed in web browsers (e.g., including but not limited to Google Chrome, Firefox, Opera, Dolphin, Internet Explorer, and/or various mobile browsers) at one or more client devices on the client-side 502. As such, in this instance, each user device becomes a part of the computing architecture without requiring any additional software or plug-in installations. In one embodiment, the other portions of the analytics computed by other client devices are stored at a server (e.g., on the server side 504) and the client device communicates with the server 504 to obtain the other portions of the analytics used to present the indicators at the client device.

Note that a server on the server side 504 is capable of computing any or all of the analytics of the commonly or frequently occurring topics though it need not do so. For example, the computing of any or all of the analytics of the commonly or frequently occurring topics can be dynamically adjusted between the server side 504 and the client. In one embodiment, the computing of the analytics of the commonly or frequently occurring topics can be automatically shifted to the server if the client device goes off line or malfunctions.

The computing can automatically shift back to the client device when the client device goes back online. In some instances, the client device on the client side 502 can transmit the analytics to the server-side 504 components for storage or additional processing, and/or for subsequent use by other client devices. The analytics and messages/content can be stored on the server-side 504 at the data store.

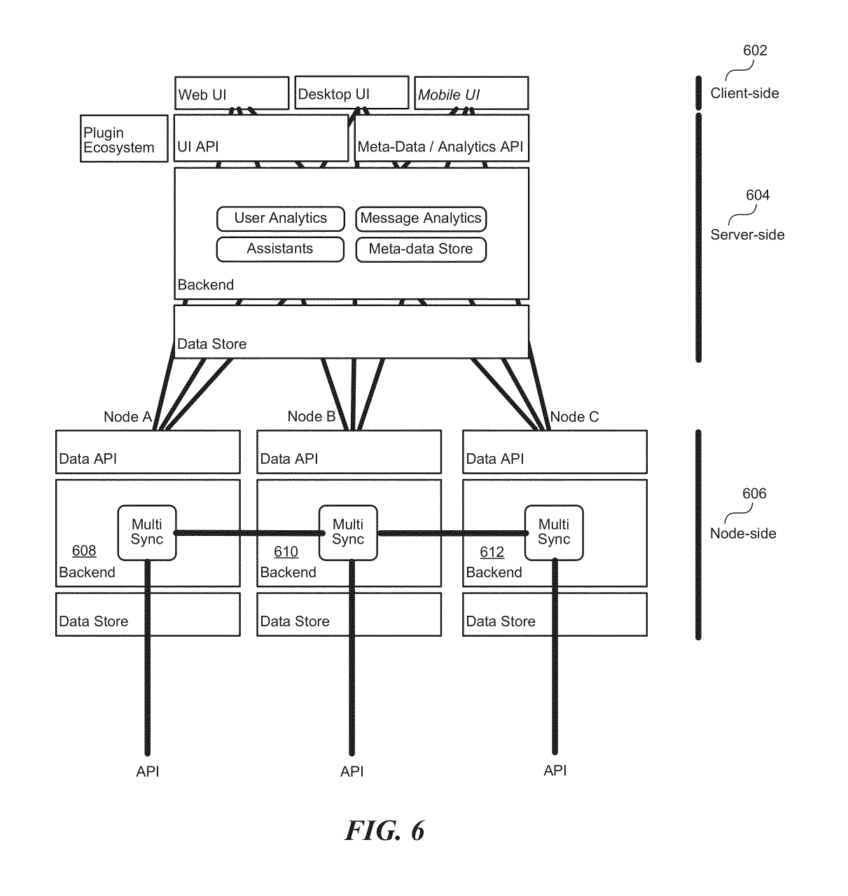

Note that in general, the server-side 504 component can also include multiple servers or multiple nodes for further load distribution and redundancy purposes, as shown in the following example of FIG. 6. FIG. 6 illustrates another example architecture of a system which analyzes messages in a network or across networks to/from various online media sites and/or users.

In the example architecture of FIG. 6, the server-side 604 component includes or is distributed into multiple nodes on shown as node-side components 606. In this example, one or more servers on the server side 604 can determines interests of the user from online activity of the user at the online media services and increases visibility of those incoming messages which are more interesting to the user among other incoming messages in the stream for presentation in a user interface.

In one embodiment, the online activity of the user can be automatically detected at multiple nodes on the node side 606 coupled to the server side 604, each of which able to query one or more of the online media services (e.g., Facebook, Linkedin, Twitter, Quora, Yammer, etc.). In some instances, two or more multiple nodes can be coupled to each other such that external services can be queried or accessed in redundancy in case any of the nodes are banned, malfunctions, or needs servicing. In general, the multiple nodes of 606 can query external APIs of the online media services to access the messages/content and/or user activities.

In some instances, different nodes are assigned to different sets of users in the multiple users. For example, a given node creates or extracts metadata from the incoming messages for use analyzing the incoming messages for those users who are assigned to the given node. The given node can further analyze the incoming messages for its assigned users. In one embodiment, the personalized message streams are stored at the different nodes based on user assignment. Different nodes can be assigned to different sets of users in the multiple users but with redundancy. The user interface components on the client side 604 of can be coupled to the multiple nodes and are able to depict the personalized messages streams stored on the multiple nodes on the node side 606.

In one embodiment, a server on the server side 604 is able to analyze the incoming messages for the users and generate message analytics. The server on the server side 604 can also generate user analytics from the online activity of the users at the online media services; where, the online activity of the user includes user interaction with content on or via the social networking services. For example, the server side component 604 can determine the interests by analyzing user content provided in the online activity at or via the social networking service, where the user content includes user-submitted content or user-generated content including by way of example one or more of, user profiles, user events, user likes or dislikes, status updates, mentions, feeds, tweets, links, notes, video content, audio content.

The server side component 604 can determines interests of the user from online activity of the users at the online media services and increases visibility of those incoming messages which are more interesting to generate the personalized message streams. The server side component 604 can also create and/or extract metadata from the incoming messages for use analyzing the incoming messages.

The incoming messages can be stored at the data stores or repositories distributed among the multiple nodes on the node side 606. In general, the server component 604 and the node-side components 606 are a part of a platform which is typically independent of any of the online media services

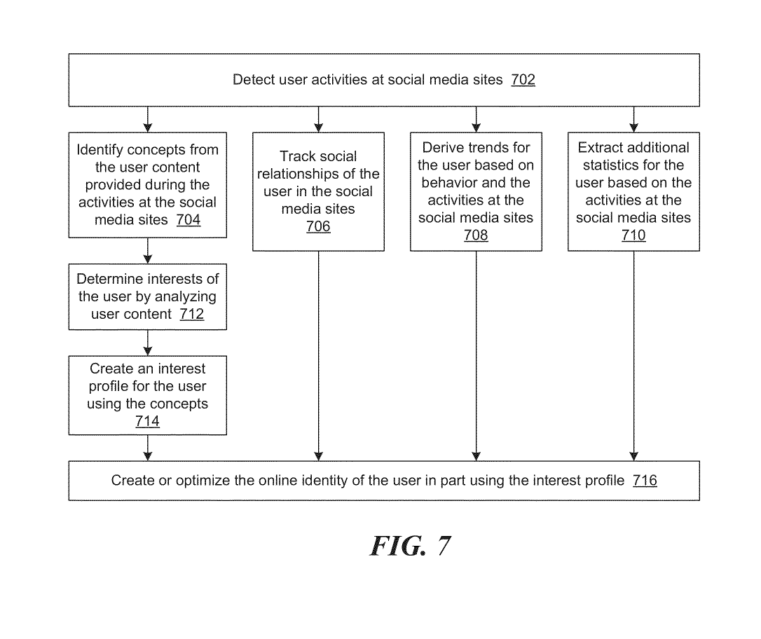

FIG. 7 depicts a flow chart illustrating an example process for aggregating an online identity of a user from activities at social media sites.

In process 702, user activities at social media sites are detected. In process 704, concepts are identified from the user content provided during the activities at the social media sites. In one embodiment, the concepts are identified using natural language processing or any other known/convenient means. In process 712, interests of the user are determined by analyzing user content. In process 714, an interest profile for the user using the concepts. In process 716, the online identity of the user is created in part using the interest profile. In process 706, social relationships of the user in the social media sites. In process 708, trends are derived for the user based on behavior and the activities at the social media sites.

In process 710, additional statistics are extracted for the user based on the activities at the social media sites. For example, the statistics can include, one or more of, a degree to which a user trusts other people on various topics, a degree to which other people trust the user on various topics, demographics information of a user, and/or social influence of the user. The additional statistics can also include, sites that the user is interested, content and products that the user is interested in, statistics about the people the user reposts or replies to, who repost or reply to the user, the people that the user is interested in. The online identify of the user can further be created/optimized using one or more of, the social relationships, the additional statistics, and/or trends determined for the user.

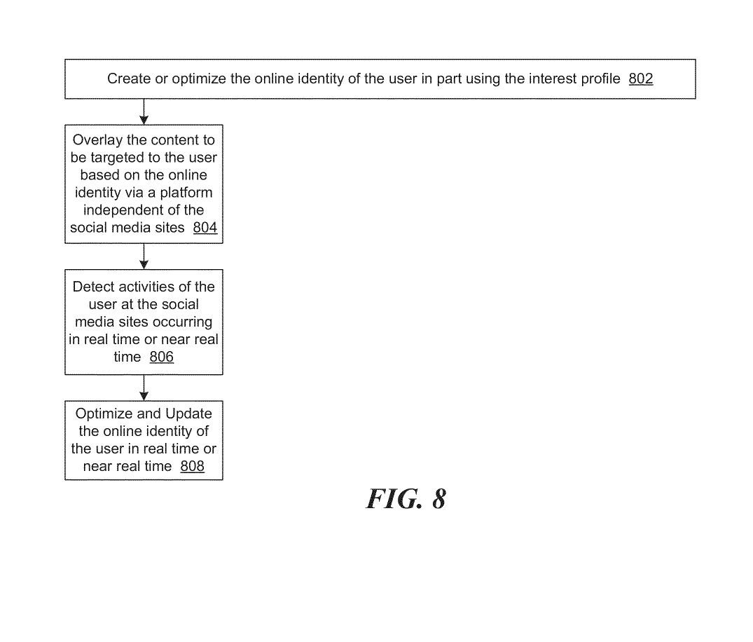

FIG. 8 depicts an example flow chart illustrating an example process for targeting content placement using online identifies aggregated a user's online activities.

In process 802, which continues from FIG. 7, the online identity has been created and/or optimized from one or more of the processes of FIG. 7.

In process 804, the content to be targeted to the user is overlayed based on the online identity via a platform independent of the social media sites. The content targeted to user can be created via the platform independent of the social media sites. For example, the content targeted to the user can be created by a third party (e.g., a third party advertiser or a third party in partnership with the platform which created the online identify of the user, or a customer of the platform). In general, the content that is targeted includes one or more of, promotional content, sponsored content, advertisements, coupons, e-coupon

In process 806, activities of the user at the social media sites occurring in real time or near real time are detected. In process 808, the online identity of the user in real time or near real time is optimized and updated in real time or near real time. This allows the content to be targeted based on what the user is sending messages about or what the user is posting or tweeting about, searching for, viewing, browsing, etc. The content is targeted further based on geographical locale of the user, for example as determined from user check-ins or other location sensitive devices or location based services.

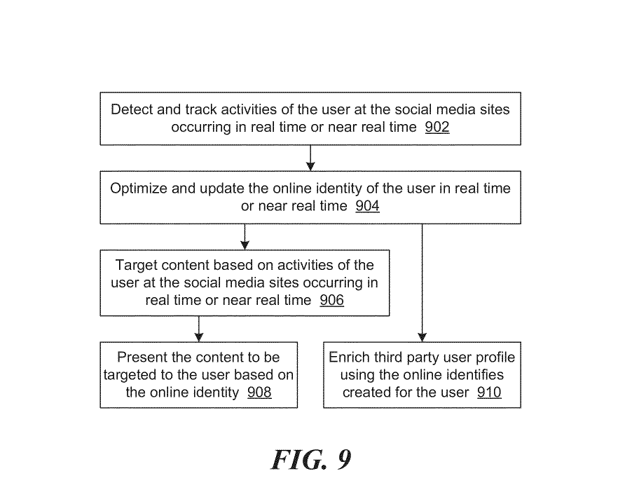

FIG. 9 depict example flow charts illustrating example processes for targeting content placement based on real time online activities of the user and enriching a third party user profile.

In process 902, activities of the user at the social media sites occurring in real time or near real time are detected and tracked.

In process 904, the online identity of the user is optimized and/or updated in real time or near real time.

In process 906, content is targeted to the user based on activities of the user at the social media sites occurring in real time or near real time. For example the content can be targeted based on what the user is sending messages about or what the user is posting or tweeting about in real time or near real time, or any real time activity within, across, or at various social media or networking sites/platforms. In one embodiment, trends for the user are derived based on behavior and the activities at the social media site and the online identity of the user is also created in part using trends derived for the user.

In process 908, the content to be targeted to the user based is presented based on the online identity, for example, by overlaying the content to be targeted to the user based on the online identity via a platform independent of the social media sites

In process 910, third party user profile is enriched using the online identifies created for the user. The third party user profile can include, for example, third party advertiser's profiles. These profiles can be supplemented by the analysis performed by the server based on the user's aggregate online presence through their behaviors, actions, connections and other activities indicating the overall online presence across multiple sites and platforms.

The profile enrichment can include data supplementing across multiple dimensions including time (e.g., trends, most recent, over all trend, past trend), across certain topics/concepts (user's preferences regarding certain topics/concepts—for example, whether the user prefers to watch football or basketball in the topic of sports), on various platforms (what the user posts or views on Facebook vs. Twitter vs. Google+, the people that they follow and/or interact with), with respect to certain users (what they interact with certain users regarding, and/or via what platform, etc. thus enabling a third party promoter or advertiser to review potential targeted users from different aspects and identify those aspects most suitable for targeting a certain ad.

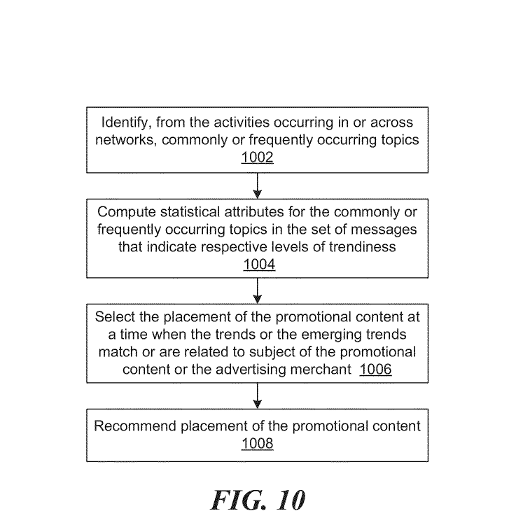

FIG. 10 depicts a flow chart illustrating an example process for recommending promotional content placement for an advertiser based on trends identified from activities occurring in or across networks.

In process 1002, commonly or frequently occurring topics are identified from activities occurring in or across networks. In process 1004, statistical attributes are computed for the commonly or frequently occurring topics in the set of messages that indicate respective levels of trendiness.

In process 1006, the placement of the promotional content/item (e.g., advertisement) is selected at a time when the trends or the emerging trends match or are related to subject of the advertisement or the advertiser. In process 1008, placement of the advertisement is recommended.

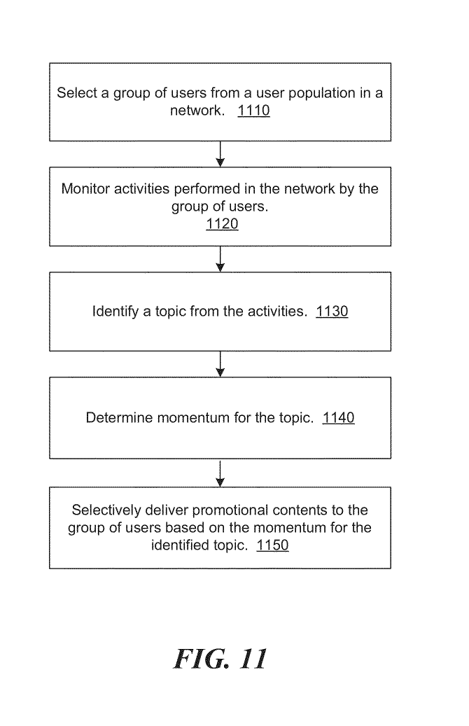

FIG. 11 depicts a flow chart illustrating an example process for dynamically placing, scheduling, and adjusting promotional items based on momentum of activities of a targeted audience in a network. The example process can be performed by, for example, the host server 300 of FIG. 3A. With additional reference to FIG. 3D, the example process of FIG. 11 is explained.

In one or more embodiments, the targeted audience selector 386 can select (1110) a group of users from a user population in a network based. The selection can be based multiple factors, including a degree of association between (i) one or more key words as designated by the merchant client who assigns the promotional content/item (e.g., advertisement), and (ii) profile data or past activities from the user population. For example, a target audience for a promotional content, such as a promoted or featured message in a social network, can be selected by the targeted selector 386. The merchant client, for example, can choose a set of initial target topics or key words 386a. Then, the targeted audience selector 386 can match the key words 386a with user data 386b to locate a particular set of the audience (or “targeted audience). The match can be based on demographics, psychographics, interest profiles, influence or engagement levels, including profile data (e.g., gender, interest, age, education, hobby, etc.) and past activities performed.

After the targeted audience is selected by the targeted audience selector 386, the trend detection and prediction engine 385 includes the targeted audience activity tracker 385a which can monitor (1120) activities performed in the network by the group of targeted audience, and includes the topic identifier 385b which can identify (1130) one or more topics from the activities. In some embodiments, the trend detection and prediction engine 385 can employ a natural language engine (e.g., natural language processing engine 331) to parse text included in the activities for the identifying of topic. Examples of sources from which the engine 385 can detect topics can include, by way of example but not limitation, nouns, noun phrases, links, usernames, tags, or concepts.

After the topic(s) is identified, the trend detection and prediction engine 385 can determine (1140) momentum for the topic. More specifically, the momentum determination module 385c can compute momentum of the topic that is identified by the topic identifier 358b. In some embodiments, the momentum is proportional to (i) a number of how many users whose activities mention the topic and (ii) a frequency of how often the topic is mentioned; for example, the momentum of each topic in a conversation can be computed by “mass” times “velocity,” where mass can represent the size of the crowd, and velocity can represent the frequency of a particular topic is mentioned. It is noted that other suitable methods can also be adapted in addition or as an alternative to the above formula in calculating the momentum.

Then, the trend detection and prediction engine 385 can selectively deliver (1150) advertisements or promotional content to the targeted group of users based on the momentum for the identified topic. More specifically, the content placement engine 384 can determine time 384a and location 384b of a promotional content is to be delivered to the group of targeted audience based on the aforementioned momentum of topics. In this way, the content targeting engine 380 enables the host server 300 to automatically deliver advertisements or promotional items or content with topics coherent or relevant to the interesting or high value momentums so that the promotional items or content can reach people who are currently paying attention to those topics.

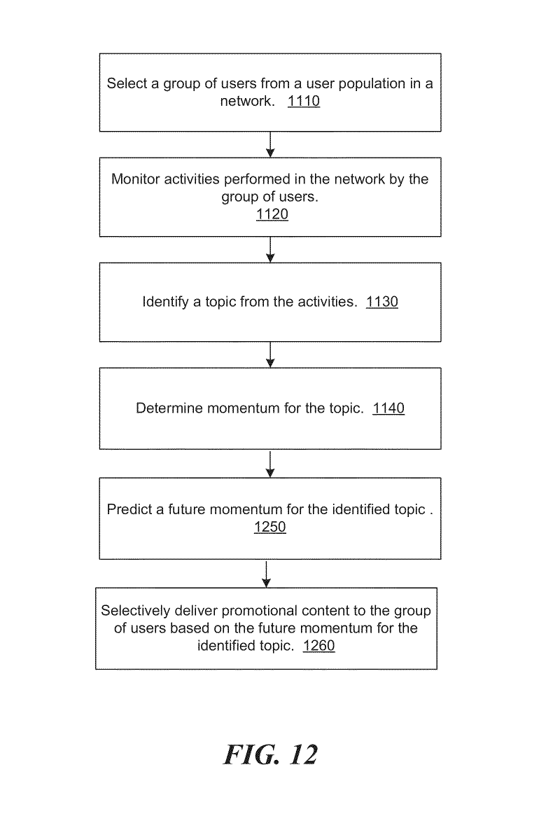

FIG. 12 depicts a flow chart illustrating an example process for predicting momentum of topic in the future in automatically optimizing placement of promotional items in a network. The example process can be performed by, for example, the host server 300 of FIG. 3A. With additional reference to FIGS. 3D and 3E, the example process of FIG. 12 is explained.

After step 1140 explained above, in some embodiments, the momentum prediction module 385d can enable the trend detection and prediction engine 385 to predict (1250) near-future or future momentum, and to predict the dynamics or changes over time for those identified topics, and/or for any other topic that is around the identified topic by measuring the momentums over time of particular topics. More specifically, the momentum prediction module 385d can predict a future momentum for the identified topic based on observing additional topics which are related to the identified topic and have momentums with a rate of growth that exceeds a positive or negative threshold. In some embodiments, the momentum vector calculator 381d-1 can compute a momentum vector for each identified topics over a select period of time. The momentum vector can comprise a line formed by tracing a magnitude of the momentum for a given topic over the select period of time. The future momentum can be predicted based on a proximate direction of the line.

Then, the trend detection and prediction engine 385 can selectively deliver (1260) advertisements or promotional content to the targeted group of users based on the future momentum for the identified topic, and/or can adjust the selective delivery as determined by aforementioned step 1150.

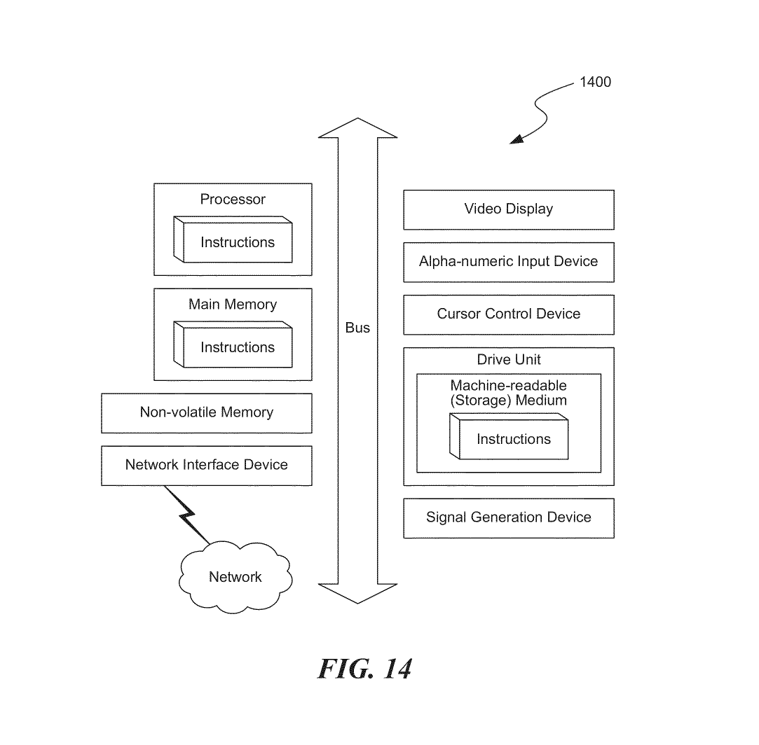

FIG. 14 shows a diagrammatic representation of a machine in the example form of a computer system within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a user device, a tablet PC, a laptop computer, a set-top box (STB), a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The network interface device enables the machine 1100 to mediate data in a network with an entity that is external to the host server, through any known and/or convenient communications protocol supported by the host and the external entity. The network interface device can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network interface device can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

What is claimed is:

1. A method for predicting further momentum to dynamically place promotional content, the method comprising:
selecting a group of users from a user population in a network;
identifying a topic from activities by monitoring the activities performed by the group of users;
determining momentum for the topic; and
predicting a future momentum for the topic based on observing additional topics which are related to the identified topic and have momentums with a rate of growth that exceeds a positive or negative threshold.

2. The method of claim 1, further comprising:
selectively causing a delivering of promotional content to the group of users based on the future momentum for the identified topic.

3. The method of claim 1, wherein the predicting comprising:
computing a momentum vector for each identified topics over a select period of time.

4. The method of claim 3, wherein the momentum vector comprises a line formed by tracing a magnitude of the momentum for a given topic over the select period of time.

5. The method of claim 4, wherein the future momentum is predicted based on a proximate direction of the line.

6. The method of claim 1, wherein the group of users is selected based on a degree of association between (i) multiple key words and (ii) profile data or past activities from the user population

7. The method of claim 1, wherein the momentum is proportional to and computed from one or more of (i) a number of how many users whose activities mention the topic, and (ii) a frequency of how often the topic is mentioned.

8. A server which predicts further momentum to dynamically place promotional content, the server comprising:
a processor; and
a memory unit having instructions stored thereon which when executed by the processor, causes the processor to:
select a group of users from a user population in a network;
identify a topic from activities by monitoring the activities performed by the group of users;
determine momentum for the topic; and
predict a future momentum for the topic based on observing additional topics which are related to the identified topic and have momentums with a rate of growth that exceeds a positive or negative threshold.

9. The server of claim 8, wherein the processor is further caused to:
selectively cause a delivering of promotional content to the group of users based on the future momentum for the identified topic.

10. The server of claim 8, wherein the processor, in performing the predicting, is further caused to:
compute a momentum vector for each identified topics over a select period of time.

11. The server of claim 10, wherein the momentum vector comprises a line formed by tracing a magnitude of the momentum for a given topic over the select period of time.

12. The server of claim 11, wherein the future momentum is predicted based on a proximate direction of the line.

13. The server of claim 8, wherein the group of users is selected based on a degree of association between (i) multiple key words and (ii) profile data or past activities from the user population.

14. The server of claim 8, wherein the momentum is proportional to and computed from one or more of (i) a number of how many users whose activities mention the topic, and (ii) a frequency of how often the topic is mentioned.

15. A method for using natural language processing to dynamically place promotional content, the method comprising:
selecting a group of users from a user population in a network based on a degree of association between (i) multiple key words and (ii) profile data or past activities from the user population;
monitoring activities performed in the network by the group of users;
identifying a topic from the activities by employing a natural language engine to parse text included in the activities for the identifying of topic, wherein the engine is configured, in the identifying of topic, to detect one or more of: nouns, noun phrases, links, usernames, tags, or concepts;
determining momentum for the topic, wherein the momentum is proportional to and computed from (i) a number of how many users whose activities mention the topic and (ii) a frequency of how often the topic is mentioned; and
selectively causing a delivering of promotional content to the group of users based on the momentum for the identified topic.

16. The method of claim 15, further comprising:
measuring a performance including a click rate of the delivered promotional content, wherein the selective delivering is adjusted based on results from the measuring.

17. The method of claim 15, further comprising:
analyzing a magnitude and a rate of growth for the momentum of the identified topic over a select period of time;
assigning a first grade to the magnitude of the momentum, and a second grade to the rate of growth of the momentum; and
identifying high value topics for adjusting the selective delivering based on a weighted sum of the first and second grades.

18. The method of claim 17, further comprising:
automatically determining a price for the selectively delivery based on the weighted sum of the first and second grades.

19. The method of claim 15, further including:
predicting a future momentum for the identified topic based on observing additional topics which are related to the identified topic and have momentums with a rate of growth that exceeds a positive or negative threshold.

20. The method of claim 19, wherein the predicting comprises:
computing a momentum vector for each identified topics over a select period of time, wherein the momentum vector comprises a line formed by tracing a magnitude of the momentum for a given topic over the select period of time, and
wherein the future momentum is predicted based on a proximate direction of the line.

21. A method for using momentum computed for a topic based on activities in a network to dynamically place the promotional content, the method comprising:
selecting a group of users from a user population in a network based on a degree of association between (i) multiple key words and (ii) profile data or past activities from the user population;
monitoring activities performed in the network by the group of users;
identifying the topic from the activities;
determining momentum for the topic, wherein the momentum is proportional to and computed from (i) a number of how many users whose activities mention the topic and (ii) a frequency of how often the topic is mentioned; and
locating interesting momentum based on analyzing a magnitude and a rate of growth for the momentum of the identified topic over a select period of time

22. The method of claim 21, further comprising:
selectively causing a delivering of promotional content to the group of users based on the interesting momentum.

23. The method of claim 21, wherein interesting momentum includes:
momentums with magnitudes that exceed a threshold.

24. The method of claim 21, wherein interesting momentum includes:
momentums with rates of growth that are positive.

25. The method of claim 21, wherein interesting momentum includes:
momentums with rates of growth that exceed a threshold.

26. The method of claim 21, wherein interesting momentum includes:
momentums with exponential growth rates.

27. The method of claim 21, further comprising:
assigning a first grade to the magnitude of the momentum, and a second grade to the rate of growth of the momentum; and
identifying high value topics for adjusting the selective delivering based on a weighted sum of the first and second grades.

28. The method of claim 27, wherein interesting momentum includes:
momentums with a weighted sum that exceed a threshold.

29. A method for optimizing delivery of targeted content, the method performed by a server, the method comprising:
selecting a group of users from a user population in a network based on a degree of association between (i) multiple key words and (ii) profile data or past activities from the user population;
monitoring activities performed in the network by the group of users;
identifying a topic from the activities;
determining momentum for the topic, wherein the momentum is proportional to and computed from (i) a number of how many users whose activities mention the topic and (ii) a frequency of how often the topic is mentioned;
analyzing a magnitude and a rate of growth for the momentum for the identified topic over a select period of time; and
automatically arranging delivery of content to the selected group of users based on the magnitude and the rate of growth for the momentum for the identified topic in a way that meets a number of budget criteria set forth by the promotional content.

30. The method of claim 29, further comprising:
measuring a performance including a click rate of the delivered content, wherein the automatic arranging is adjusted based on results from the measuring.

31. A server which dynamically places targeted promotional content, the server comprising:
a processor; and
a memory unit having instructions stored thereon which when executed by the processor, causes the processor to:
select a group of users from a user population in a network based on a degree of association between (i) multiple key words and (ii) profile data or past activities from the user population;
monitor activities performed in the network by the group of users;
identify a topic from the activities;
determine momentum for the topic, wherein the momentum is proportional to and computed from (i) a number of how many users whose activities mention the topic and (ii) a frequency of how often the topic is mentioned; and
selectively cause a delivering of promotional content to the group of users based on the momentum for the identified topic.

32. The server of claim 31, wherein the processor is further caused to:
measure a performance including a click rate of the delivered promotional content, wherein the selective delivering is adjusted based on results from the measuring.

33. The server of claim 31, wherein the processor is further caused to:
analyze a magnitude and a rate of growth for the momentum of the identified topic over a select period of time.

34. The server of claim 33, wherein the processor is further caused to:
assign a first grade to the magnitude of the momentum, and a second grade to the rate of growth of the momentum.

35. The server of claim 34, wherein the processor is further caused to:
identify high value topics for adjusting the selective delivering based on a weighted sum of the first and second grades.

36. The server of claim 34, wherein the second grade is configured to at least differentiate whether the rate of growth is: (i) positive; (ii) exponentially positive; (iii) negative; or (iv) exponentially negative.

37. The server of claim 35, wherein the processor is further caused to:
automatically determine a price for the selectively delivery based on the weighted sum of the first and second grades.

38. The server of claim 31, wherein the processor is further caused to:
employ a natural language engine to analyze sentiments from wording used in the plurality of activities.

39. The server of claim 38, wherein the processor is further caused to:
adjust the momentum based on the sentiments.

40. The server of claim 38, wherein the adjusting of the momentum reflects a degree of positivity or negativity of the sentiments.

41. The server of claim 31, wherein the momentum for the topic is determined based on momentum of conversation, which is proportional to and computed from (i) how many users who participate in the conversation and (ii) how often the conversation is renewed by the users who participate therein.

42. The server of claim 31, wherein the processor is further caused to:
predict a future momentum for the identified topic based on observing additional topics which are related to the identified topic and have momentums with a rate of growth that exceeds a positive or negative threshold.

43. The server of claim 42, wherein the processor, in performing the predicting, is further caused to:
compute a momentum vector for each identified topics over a select period of time, wherein the momentum vector comprises a line formed by tracing a magnitude of the momentum for a given topic over the select period of time, and
wherein the future momentum is predicted based on a proximate direction of the line.

44. The server of claim 31, wherein the processor, in performing the detecting, is further caused to:
employ a natural language engine to parse text included in the activities for the identifying of topic, wherein the engine is configured to detect one or more of: nouns, noun phrases, links, usernames, tags, or concepts.

45. The server of claim 31, wherein the processor is further caused to:
suggest, to an administrator, potential topics for the potential topics to be added into the key words.

46. The server of claim 31, wherein the processor is further caused to:
suggest, to an administrator, sets of topics to be grouped together to adjust the selective delivering.

47. The server of claim 31, wherein the processor is further caused to:
suggest, to an administrator, sets of topics to adjust the selective delivering based on a cost of the promotional content.

48. The server of claim 31, wherein the profile data or past activities include one or more of: posts, likes, interest profiles, demographics, psychographics, influence or engagement levels, or geographical regions.

49. The server of claim 31, wherein the plurality of activities being monitored include one or more of: posts, tweets, status updates, likes, shares, replies, reading activities, or searches.

50. The server of claim 31, wherein the monitoring, the identifying of topic, the determining of momentum, and the selective delivering steps are repeatedly performed by the processor per select period of time.

51. The server of claim 31, wherein the processor performs the steps in real-time or near real-time.

52. A server which uses natural language processing to dynamically place promotional content, the server comprising:
a processor; and
a memory unit having instructions stored thereon which when executed by the processor, causes the processor to:
select a group of users from a user population in a network based on a degree of association between (i) multiple key words and (ii) profile data or past activities from the user population;
monitor activities performed in the network by the group of users;
identify a topic from the activities by employing a natural language engine to parse text included in the activities for the identifying of topic, wherein the engine is configured, in the identifying of topic, to detect one or more of: nouns, noun phrases, links, usernames, tags, or concepts;
determine momentum for the topic, wherein the momentum is proportional to and computed from (i) a number of how many users whose activities mention the topic and (ii) a frequency of how often the topic is mentioned; and
selectively cause a delivering of promotional content to the group of users based on the momentum for the identified topic.

53. The server of claim 52, wherein the processor is further caused to:
measure a performance including a click rate of the delivered promotional content, wherein the selective delivering is adjusted based on results from the measuring.

54. The server of claim 52, wherein the processor is further caused to:
analyze a magnitude and a rate of growth for the momentum of the identified topic over a select period of time;
assign a first grade to the magnitude of the momentum, and a second grade to the rate of growth of the momentum; and
identify high value topics for adjusting the selective delivering based on a weighted sum of the first and second grades.

55. The server of claim 54, wherein the processor is further caused to:
automatically determine a price for the selectively delivery based on the weighted sum of the first and second grades.

56. The server of claim 52, wherein the processor is further caused to:
predict a future momentum for the identified topic based on observing additional topics which are related to the identified topic and have momentums with a rate of growth that exceeds a positive or negative threshold.

57. The server of claim 56, wherein the processor, in performing the predicting, is further caused to:
compute a momentum vector for each identified topics over a select period of time, wherein the momentum vector comprises a line formed by tracing a magnitude of the momentum for a given topic over the select period of time, and
wherein the future momentum is predicted based on a proximate direction of the line.

58. A system which dynamically places targeted promotional content, the system comprising:
means for selecting a group of users from a user population in a network based on a degree of association between (i) multiple key words and (ii) profile data or past activities from the user population;
means for monitoring activities performed in the network by the group of users;
means for identifying a topic from the activities;
means for determining momentum for the topic, wherein the momentum is proportional to and computed from (i) a number of how many users whose activities mention the topic and (ii) a frequency of how often the topic is mentioned; and
means for selectively causing a delivering of promotional content to the group of users based on the momentum for the identified topic.

59. The system of claim 58, further comprising:
means for analyzing a magnitude and a rate of growth for the momentum of the identified topic over a select period of time;
means for assigning a first grade to the magnitude of the momentum, and a second grade to the rate of growth of the momentum; and
means for identifying high value topics for adjusting the selective delivering based on a weighted sum of the first and second grades.

60. A system for predicting further momentum to dynamically place promotional content, the system comprising:
means for selecting a group of users from a user population in a network;
means for identifying a topic from activities by monitoring the activities performed by the group of users;
means for determining momentum for the topic; and
means for predicting a future momentum for the topic based on observing additional topics which are related to the identified topic and have momentums with a rate of growth that exceeds a positive or negative threshold.
